(19) United States
(12) Patent Application Publication
(10) Pub. No.: US 2017/0336695 A1
(43) Pub. Date: Nov. 23, 2017

(54) MULTIBAND WAVELENGTH SELECTIVE DEVICE

(71) Applicant: FLIR Surveillance, Inc., Wilsonville, OR (US)

(72) Inventor: Irina PUSCASU, Winchester, MA (US)

(73) Assignee: FLIR Surveillance, Inc., Wilsonville, OR (US)

(21) Appl. No.: 15/522,505

(22) PCT Filed: Nov. 4, 2015
(86) PCT No.: PCT/US2015/058910

§ 371 Date: Apr. 27, 2017

Related U.S. Application Data
(60) Provisional application No. 62/075,075, filed on Nov. 4, 2014.

(51) Int. Cl. G02F 1/19; G02B 5/00; G01J 5/02; H01Q 15/00; H01Q 1/42

(52) U.S. Cl. CPC G02F 1/19; H01Q 15/0066; H01Q 1/425; G01J 5/024; G02B 5/008; H01Q 1/422

(57) ABSTRACT

A tunable electromagnetic radiation device that includes a wavelength selective structure comprising a plurality of layers. The plurality of layers includes a compound layer comprising a plurality of surface elements, an electrically isolating intermediate layer, and a continuous electrically conductive layer. The compound layer includes at least one metallic layer or metallic-like layer and at least one dielectric layer and is in contact with a first surface of the electrically isolating intermediate layer. The continuous electrically conductive layer is in contact with a second surface of the electrically isolating intermediate layer. The wavelength selective structure has at least one reflective or absorptive resonance band. The tunable electromagnetic radiation device further includes an electrode in electrical contact with at least one of the compound layer, the electrically isolating intermediate layer, and the continuous electrically conductive layer.

### FIELD OF THE APPLICATION

The present application relates generally to wavelength selective devices based on plasmonic surface structures, and more particularly wavelength selective devices with a plurality of resonances.

### BACKGROUND

Wavelength selective surfaces can be provided to selectively reduce reflections from incident electromagnetic radiation. Such surfaces may be employed in signature management applications to reduce radar returns. These applications are typically employed within the radio frequency portion of the electromagnetic spectrum.

The use of multiple wavelength selective surfaces disposed above a ground plane, for radio frequency applications, is described in U.S. Pat. No. 6,538,596 to Gilbert. Gilbert relies on the multiple wavelength selective surfaces providing a virtual continuous quarter wavelength effect. Such a quarter wavelength effect results in a canceling of the fields at the surface of the structure. Thus, although individual layers may be spaced at less than one-quarter wavelength (e.g., λ/12 or λ/16), Gilbert relies on macroscopic (far field) superposition of resonances from three of four sheets, such that the resulting structure thickness will be on the order of one-quarter wavelength.

The use of electrically conductive surface elements to create a tunable absorptive structures/devices is described in U.S. Pat. No. 7,956,793 to Puscasu et al. Puscasu uses a single conductive layer with a plurality of surface elements to create a tunable primary resonance related to the size of the surface elements. A less efficient secondary resonance is defined by the center-to-center spacing of the plurality of surface elements. The resonances of Puscasu are created in the visible and infrared portion of the electromagnetic spectrum.

### SUMMARY

The inventors have recognized and appreciated that there is a need for a wavelength selective device in the visible and infrared portion of the electromagnetic spectrum with a plurality of highly absorptive and/or reflective resonances. The inventors have also recognized and appreciated that engineered structures may be used as electromagnetic radiation emitters and detectors. For example, emitters and detectors using engineered structures according to some embodiments may emit or detect in the visible and/or infrared portions of the electromagnetic spectrum.

Accordingly, some embodiments are directed to a tunable electromagnetic radiation device that includes a wavelength selective structure comprising a plurality of layers. The plurality of layers includes a compound layer comprising a plurality of surface elements, an electrically isolating intermediate layer, and a continuous electrically conductive layer. The compound layer includes at least one metallic layer or metallic-like layer and at least one dielectric layer and is in contact with a first surface of the electrically isolating intermediate layer. The continuous electrically conductive layer is in contact with a second surface of the electrically isolating intermediate layer. The wavelength selective structure has at least one reflective or absorptive resonance band. An over layer may cover at least a portion of the compound layer. The tunable electromagnetic radiation device further includes an electrode in electrical contact with at least one of the compound layer, the electrically isolating intermediate layer, the continuous electrically conductive layer and the over layer. Additionally, the wavelength selective structure comprises a material having a material property that is variable in response to an external signal applied to the tunable electromagnetic radiation device, and wherein variation in the material property tunes the at least one reflective, absorptive, or emissive resonance band.

Some embodiments are directed to an electromagnetic radiation detector that includes a wavelength selective structure comprising a plurality of layers. The plurality of layers include a compound layer comprising a plurality of surface elements, an electrically isolating intermediate layer, and a continuous electrically conductive layer. The compound layer includes at least one metallic layer and at least one dielectric layer and is in contact with a first surface of the electrically isolating intermediate layer. The continuous electrically conductive layer is in contact with a second surface of the electrically isolating intermediate layer. An over layer may cover at least a portion of the compound layer. The wavelength selective structure has at least one reflective or absorptive resonance band. The electromagnetic radiation detector further includes an electrode in electrical contact with at least one of the compound layer, the electrically isolating intermediate layer, the continuous electrically conductive layer and the over layer. The wavelength selective structure comprises a material having a material property that is variable in response to an external signal applied to the detector via the electrode, and wherein variation in the material property tunes the at least one absorptive resonance band. The detector is configured to detect electromagnetic radiation in the at least one absorptive resonance band.

Some embodiments are directed to a method of selectively reflecting incident electromagnetic radiation. The method includes providing a wavelength selective structure comprising a plurality of layers, the plurality of layers including a compound layer comprising a plurality of surface elements, an electrically isolating intermediate layer, and a continuous electrically conductive layer. The compound layer includes at least one metallic layer and at least one dielectric layer and is in contact with a first surface of the electrically isolating intermediate layer. The continuous electrically conductive layer in contact with a second surface of the electrically isolating intermediate layer. The wavelength selective structure has at least one resonance band for selectively reflecting or absorbing incident visible or infrared radiation. The method further comprises receiving the incident electromagnetic radiation at the wavelength selective structure, absorbing a first portion of the incident electromagnetic radiation in the at least one resonant absorption band, and, reflecting a second portion of the incident electromagnetic radiation outside of the at least one resonant absorption band.

Some embodiments are directed to a method of emitting electromagnetic radiation. The method includes providing a wavelength selective device comprising a plurality of layers. The plurality of layers include a compound layer comprising a plurality of surface elements, an electrically isolating intermediate layer, a continuous electrically conductive layer, and an electrode in electrical contact with at least one of the compound layer, the electrically isolating intermediate layer, and the continuous electrically conductive layer. The compound layer includes at least one metallic layer and at least one dielectric layer and is in contact with a first surface of the electrically isolating intermediate layer. The continuous electrically conductive layer is in contact with a second surface of the electrically isolating intermediate layer. The wavelength selective device has at least one resonance emission band and includes a material having a material property that is variable in response to an external signal applied to the tunable electromagnetic radiation device via the electrode. The variation in the material property tunes the at least one resonance emission band. The method further comprises heating the wavelength selective device such that the wavelength selective device emits radiation in the at least one resonance emission band.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 shows a top perspective view of one embodiment of a wavelength selective structure having a rectangular array of surface elements;

FIG. 2 shows a top planar view of the wavelength selective surface of FIG. 1;

FIG. 3 shows a top planar view of another embodiment of a wavelength selective structure in accordance with the principles of the present invention having a hexagonal array of square surface elements;

FIG. 4 shows a top planar view of another embodiment of a wavelength selective structure having two different arrays;

FIG. 5 shows a top planar view of an alternative embodiment of the structure of FIG. 4;

FIG. 6 shows a top perspective view of an alternative embodiment of a wavelength selective structure having apertures defined in a compound layer;

FIG. 7A shows a cross-sectional elevation view of the wavelength selective structure of FIG. 1 taken along A-A;

FIG. 7B shows a cross-sectional elevation view of the wavelength selective structure of FIG. 6 taken along B-B;

FIG. 7C shows a cross-sectional elevation view of an alternative embodiment of a wavelength selective structure with the intermediate layer only under the surface elements;

FIG. 7D shows a cross-sectional elevation view of an alternative embodiment of a wavelength selective structure having a second intermediate layer;

FIG. 7E shows a cross-sectional elevation view of an alternative embodiment of a wavelength selective structure with a compound layer including different size metal layers within a single surface feature;

FIG. 8A shows a cross-sectional elevation view of an alternative embodiment of a wavelength selective structure having an over layer covering the compound layer;

FIG. 8B shows a cross-sectional elevation view of an alternative embodiment of a wavelength selective structure having an over layer covering the compound layer;

FIG. 8C shows a cross-sectional elevation view of an alternative embodiment of a wavelength selective structure having an over layer partially filling the gaps between the surface features of the compound layer;

FIG. 8D shows a cross-sectional elevation view of an alternative embodiment of a wavelength selective structure having a conformal over layer covering the compound layer;

FIG. 9 shows in graphical form, example reflectivity-versus-wavelength responses and the results of varying the periodicity and size of the surface elements;

FIG. 10 shows, in graphical form, example reflectivity-versus-wavelength responses and the results of varying the material of one of the layers within the structure;

FIG. 11A shows, in graphical form, example reflectivity-versus-wavelength responses and the results of varying the thickness of the dielectric intermediate layer;

FIG. 11B shows, in graphical form, example reflectivity-versus-wavelength responses according to one dual band embodiment;

FIG. 11C shows, in graphical form, example absorption/emission—versus-wavelength responses according to one dual band embodiment;

FIG. 11D shows, in graphical form, example absorption/emission—versus-wavelength responses according to one triple band embodiment;

FIG. 11E shows, in graphical form, example absorption/emission—versus-wavelength responses according to one triple band embodiment;

FIG. 12 is a cross-sectional elevation of an embodiment packaged in a TO-8 windowed can;

FIG. 13 is a plan view of an embodiment formed in a serpentine ribbon;

FIG. 14 is an example bridge drive circuit for a wavelength selective device constructed in accordance with some embodiments;

FIG. 15A shows in schematic form an embodiment of a substance detector including a single element source and detector with a spherical minor;

FIG. 15B shows in schematic form an alternative embodiment of a substance detector including separate source and detector elements using a reflective surface;

FIG. 16A is a side elevation of one embodiment of a wavelength selective device having a controllable conductivity over layer;

FIG. 16B is a top perspective diagram of an embodiment of a wavelength selective device having a controllable conductivity over layer;

FIG. 17 is a plan view of an embodiment of a pixel incorporating wavelength selective devices;

FIG. 18 is a schematic plan view of a matrix display incorporating the pixels of FIG. 16;

FIG. 19 shows an example wafer level vacuum packaging for a multitude of wavelength selective devices according to some embodiments; and

FIG. 20 shows, in graphical form, example power output versus vacuum level for some embodiments.

### DETAILED DESCRIPTION

The inventors have recognized that multilayer surface elements provided on a surface of a dielectric that is itself on a surface of a conductive layer result in multiple resonances in the visible and infrared portions of the electromagnetic spectrum. The peak wavelength, bandwidth and efficiency of the resonances may be suitably tuned by manufacturing the surface elements to have particular sizes and/or shapes, and/or to be distributed in particular arrangements on a surface, and/or by choice of the materials from which any of the layers in the structure is formed, and/or the thicknesses of any of the layers of the structure. In this way, the resonances may be matched to bands of interest for particular applications. For example, resonances may be individually tuned in the short wavelength infrared (SWIR), long wavelength infrared (LWIR), mid-wavelength infrared (MWIR), or visible portions of the electromagnetic spectrum.

In some embodiments, the resonances may be absorptive resonances and/or reflective resonances. In other embodiments, an emitter comprising multilayer surface elements may be used as an emitter of electromagnetic radiation in resonance bands of the emitter. In other embodiments, a detector comprising multilayer surface elements may be used as a detector of electromagnetic radiation in in resonance bands of the detector. The resonances may be tuned using two different approaches. First, the resonances may be “statically tuned” by selecting the characteristics of the wavelength selective structure during manufacture. For example, the types of materials used, the size of the multilayer surface elements, the distances between the multilayer surface elements, the shape of the metal layers in the multilayer surface elements, the thicknesses of the various layers in the multilayer surface elements, introduction of defects in the array of the multilayer surface elements, the shape, material, and/or thickness of any of the layers in the structure or in particular of the over layer that covers the multilayer surface elements may be selected such that one or more of the resonances have the desired characteristics. Second, the resonances may be “dynamically tuned” by, during use of the wavelength selective device, tuning one or more properties of one or more of the layers of the wavelength selective surface. For example, the conductivity, the index of refraction and/or the index of absorption may be tuned. The one or more properties may be tuned in any suitable way. For example, the temperature of one or more of the layers may be controlled and/or an electrical current may be applied to one or more of the layers.

In some embodiments, the surface elements are raised “patches” that are disposed on an electrically isolating intermediate layer. In other embodiments, the surface elements are holes formed in a multilayer compound layer. In some embodiments, a first portion of surface elements may be holes while a second portion of the surface elements may be patches.

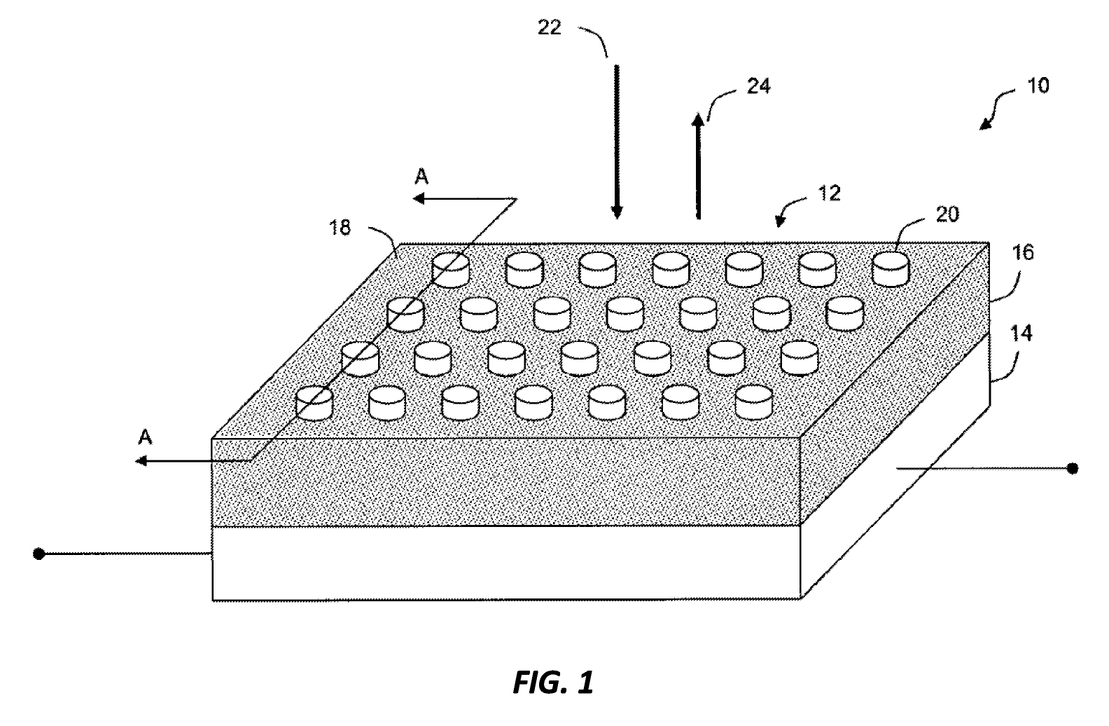

FIG. 1 illustrates a wavelength selective structure 10 according to some embodiments of the present application. The wavelength selective structure 10 includes at least three distinguishable layers. The first layer is an compound layer 12 including an arrangement of surface elements 20. The compound layer 12 includes a plurality of layers not shown in FIG. 1, but discussed in detail below. The surface elements 20 of the compound layer 12 are disposed at a height above an inner layer including a continuous electrically conductive sheet, or ground layer 14. The arrangement of surface elements 20 and ground layer 14 is separated by an intermediate layer 16 disposed there between. At least one function of the intermediate layer 16 is to maintain a physical separation between the arrangement of surface elements 20 and the ground layer 14. The intermediate layer 16 also provides at least some electrical isolation between the compound layer 12 and the ground layer 14.

In some embodiments, wavelength selective structure 10 is exposed to incident electromagnetic radiation 22. A variable portion of the incident radiation 22 is coupled to the wavelength selective structure 10. The level of coupling may depend at least in part upon the wavelength of the incident radiation 22 and a resonant wavelength of the wavelength selective structure 10, as determined by related design parameters. Radiation coupled to the wavelength selective structure 10 can also be referred to as absorbed radiation. At other non-resonant wavelengths, a substantial portion of the incident radiation is reflected 24.

In more detail, the compound layer 12 includes multiple discrete surface features, such as the surface elements 20 arranged in a pattern along a surface 18 of the intermediate layer 16. In some embodiments, the discrete nature of the arrangement of surface features 20 requires that individual surface elements 20 are isolated from each other. In these embodiments, there is no interconnection between surface elements. However, embodiments are not so limited. In other embodiments there may be one or more interconnections of two or more individual surface elements 20 by electrically conducting paths. Though not illustrated in FIG. 1, two or more individual surface elements may be connected electrically to form a composite surface element which gives rise to a new resonance. For example, two or more individual surface elements may be connected by at least one metal interconnection. Alternatively, the interconnection between the two or more individual surface elements may be formed from the same compound layers as the individual surface elements themselves. The individual surface elements can be provided with their own independent electrodes and/or connections and/or circuits and each individual surface element may have its properties varied through the application of an external signal not limited to optical, thermal, electrical, biological, chemical, and nuclear.

The compound layer 12 including an arrangement of surface elements 20 is typically flat, having a smallest dimension, height, measured perpendicular to the intermediate layer surface 18. However, embodiments are not limited to have a flat arrangement of surface elements 20. In other embodiments, a first portion of the surface elements 20 may have a first height and a second portion of the surface elements 20 may have a second height different from the first height. In general, each surface element 20 defines a surface shape and a height or thickness measured perpendicular to the intermediate layer surface 18. In general, the surface shape can be any shape, such as closed or open curves, regular polygons, irregular polygons, star-shapes having three or more legs, and other closed structures bounded by piecewise continuous surfaces including one or more curves and lines. In some embodiments, the surface shapes can include annular features, such as ring shaped patch with an open center region. More generally, the annular features have an outer perimeter defining the outer shape of the patch and an inner perimeter defining the shape of the open inner region of the patch. Each of the outer an inner perimeters can have a similar shape, as in the ring structure, or a different shape. Shapes of the inner and outer perimeters can include any of the closed shapes listed above (e.g., a round patch with a square open center). A non-exhaustive list of possible shapes include: a circle; an ellipse; an annular ring; a rectangle; a square; a square ring; a triangle; a hexagon; an octagon; parallelogram; a cross; a Jerusalem cross; a double circle; an open annular ring; and an open square ring.

While FIG. 1 illustrates all surface elements having the same shape, size, spacing, number of layers, material types and layer thicknesses, in some embodiments, the shape, size, spacing, number of layers, material types and layer thicknesses of the surface elements may differ from surface element to surface element. For example, some embodiments may include two superimposed periodic patterns of surface elements, each periodic pattern associated with a different set of characteristics. In other embodiments, defects may be introduced to an array of surface elements by, for example, slightly displacing every Nth surface element with respect to the periodicity of the array and/or using a different size or shape surface element for every Nth surface element. In other embodiments, every Nth surface element may be a different size (slightly larger or smaller), a different shape, a different material, or a different thickness. Such defects may add one or more resonances and/or affect the properties of resonances that exist absent said defect. In general, not all surface elements have to be the same in composition, shape, size or material. Additionally, not all surface elements have to be the same type. For example, a first portion of the surface elements may be patches while a second portion of the elements may be holes.

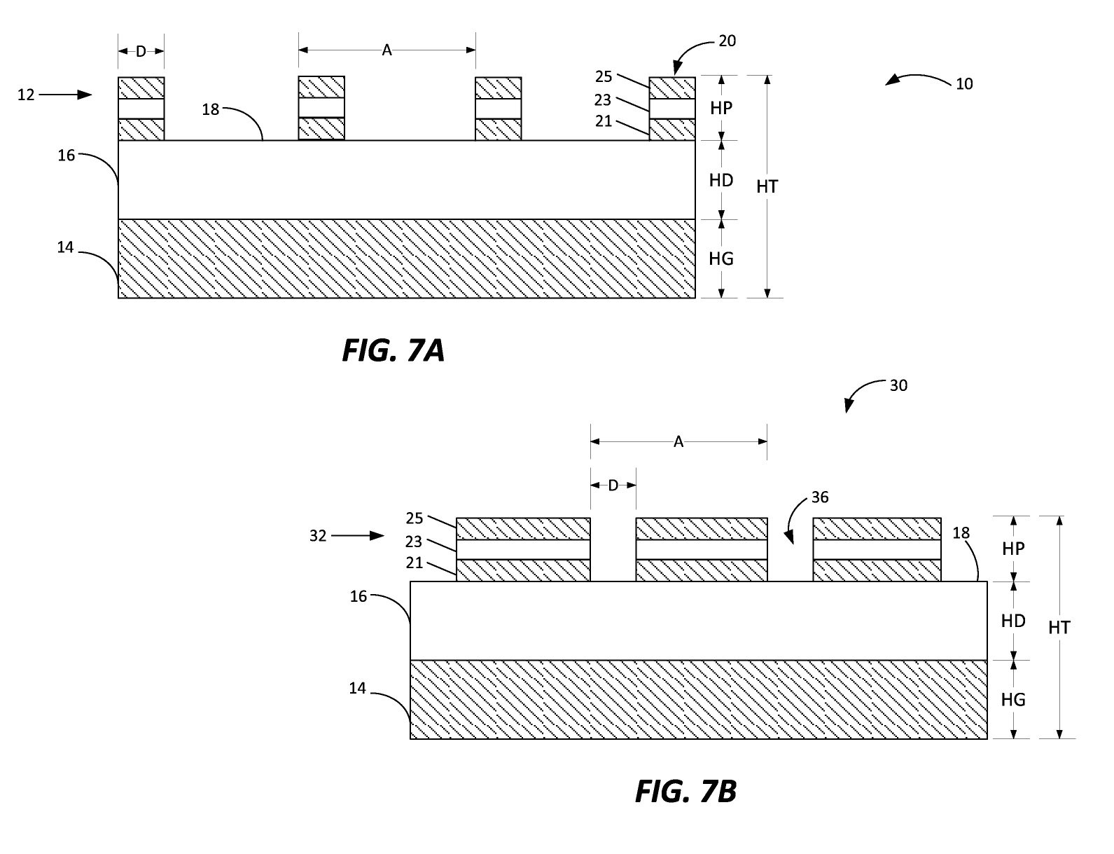

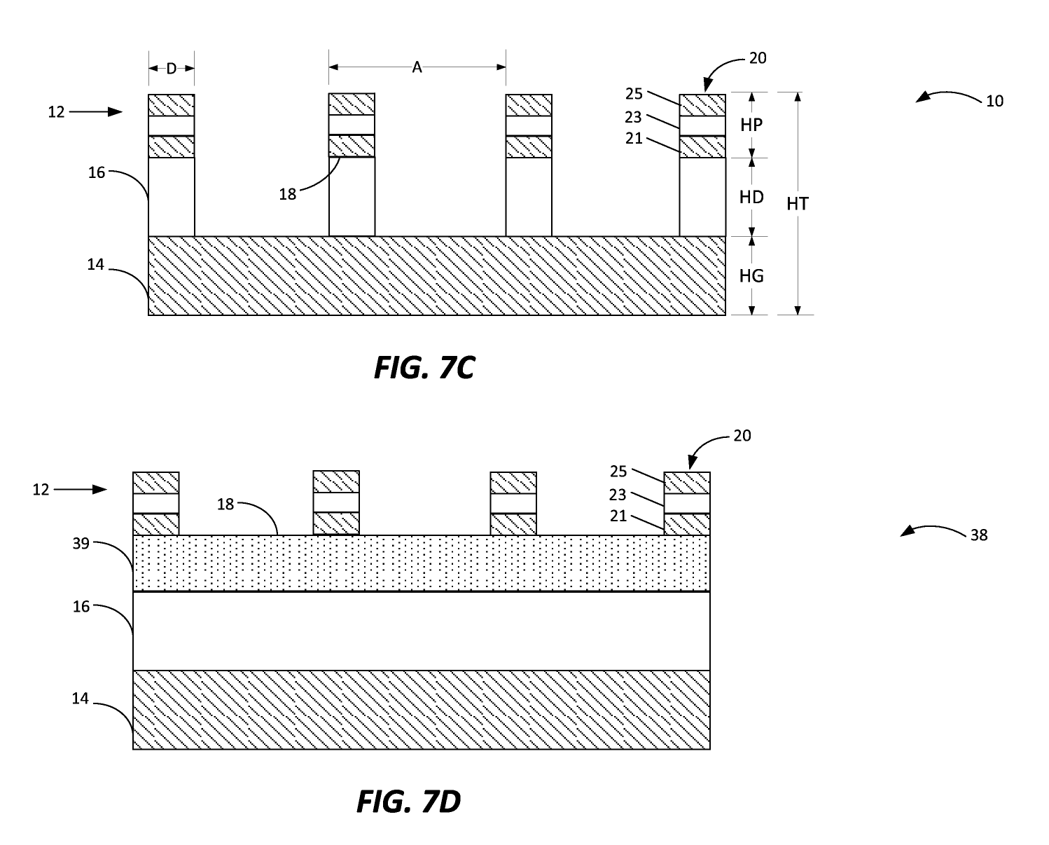

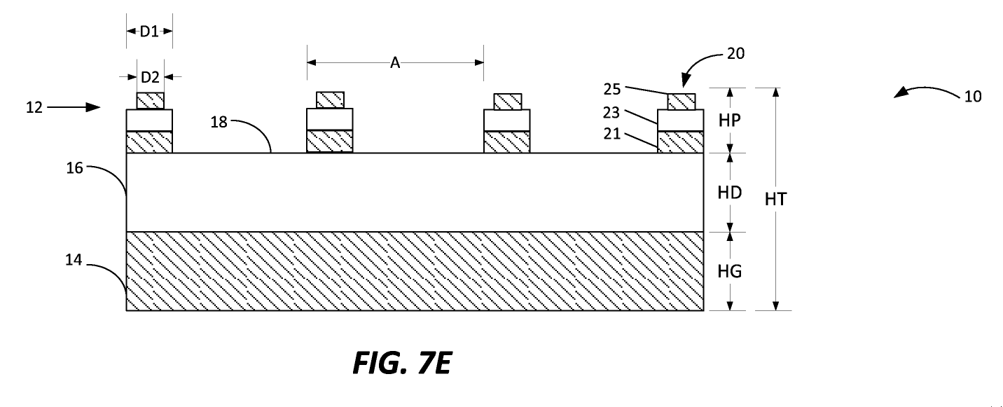

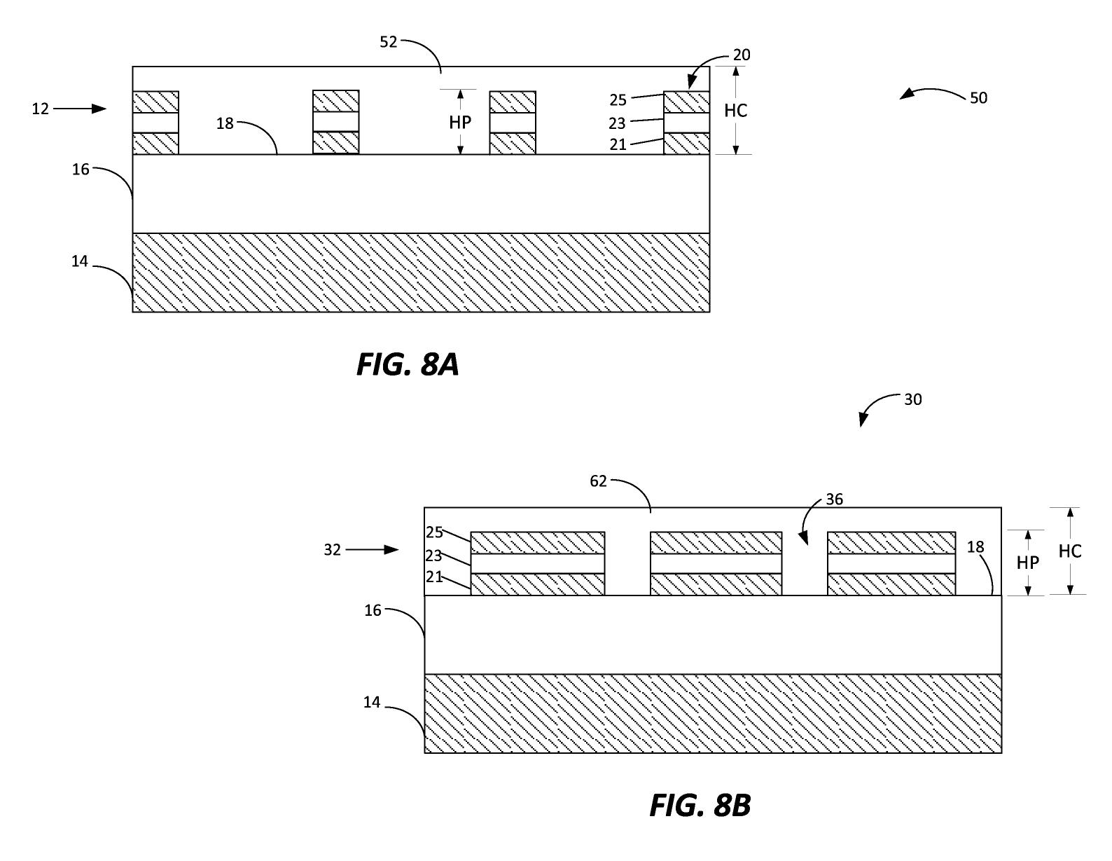

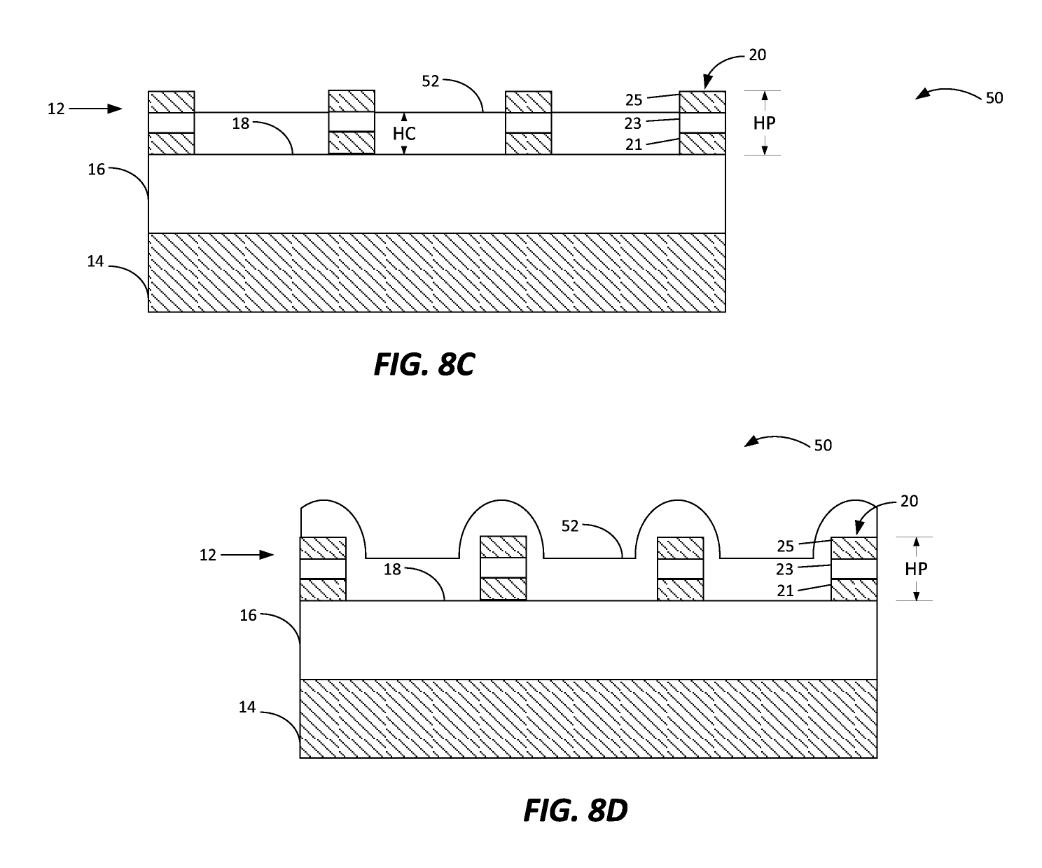

Also, as later described in connection with FIG. 7A-8D the layers within each surface element may have the same size and shape. However, embodiments are not so limited. In some embodiments, within each surface element, the different layers may have different shapes and sizes. For example, a first metal layer of a surface element may be larger in diameter than a second metal layer of the same surface element. Additionally, the first metal layer and/or the dielectric layers may be a different shape from the second metal layer of the surface element.

Each of the surface elements 20 may include multiple layers comprising electrically conductive materials, dielectric materials, and/or semiconductor materials. For example, in some embodiments, the surface elements 20 are formed in a compound layer that comprises alternating layers of dielectric and metal layers.

The conductive materials may include, but are not limited to, ordinary metallic conductors, such as aluminum, copper, gold, silver, iron, nickel, tin, lead, platinum, titanium, tantalum and zinc; combinations of one or more metals in the form of superimposed multilayers or a metallic alloy, such as steel; and ceramic conductors such as indium tin oxide and titanium nitride. In some embodiments, the electrically conductive material may include a metallic-like material, such as a heavily doped semiconductors doped with one or more impurities in order to increase the electrical conductivity.

The semiconductor materials of the surface elements 20 may include, but are not limited to: silicon and germanium; compound semiconductors such as silicon carbide, gallium-arsenide and indium-phosphide; and alloys such as silicon-germanium and aluminum-gallium-arsenide.

The dielectric materials of the surface elements 20 may be formed from an electrically insulative material. Some examples of dielectric materials include silicon dioxide (SiO2); alumina (A1203); aluminum oxynitride; silicon nitride (Si3N4). Other exemplary dielectrics include polymers, rubbers, silicone rubbers, cellulose materials, ceramics, glass, and crystals. Dielectric materials also include: semiconductors, such as silicon and germanium; compound semiconductors such as silicon carbide, gallium-arsenide and indium-phosphide; and alloys such as silicon-germanium and aluminum-gallium-arsenide; and combinations thereof

The ground layer 14 may be formed from any one of the aforementioned electrically conductive materials.

The intermediate layer 16 can be formed from any one of the aforementioned electrically insulative materials. As dielectric materials tend to concentrate an electric field within themselves, an intermediate dielectric layer 16 may do the same, concentrating an induced electric field between each of the surface elements 20 and a proximal region of the ground layer 14. Beneficially, such concentration of the electric-field tends to enhance electromagnetic coupling of the arrangement of surface elements 20 to the ground layer 14.

Dielectric materials can be characterized by parameters indicative of their physical properties, such as the real and imaginary portions of the index of refraction, often referred to as “n” and “k.” Although constant values of these parameters n, k can be used to obtain an estimate of the material's performance, these parameters are typically wavelength dependent for physically realizable materials. In some embodiments, the intermediate layer 16 includes a so-called high-k material. Examples of such materials include oxides, which can have k values ranging from 0.001 up to 10.

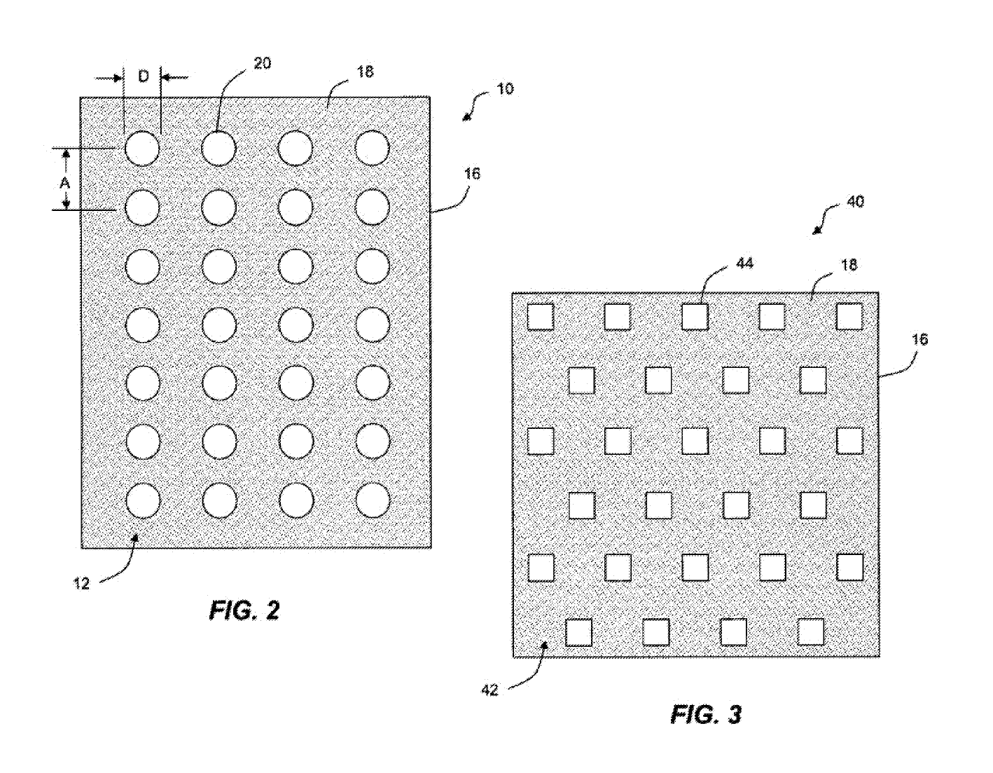

The arrangement of surface elements 20 can be configured in a non-array arrangement, or array on the intermediate layer surface 18. Referring now to FIG. 2, the wavelength selective structure 10 includes an array of surface elements 20, each surface element 20 being part of a compound layer 12. Multiple surface elements 20 are arranged in a square grid along the intermediate layer surface 18. A square grid or matrix arrangement is an example of a regular array, meaning that spacing between adjacent surface elements 20 is substantially uniform. Other examples of regular arrays, or grids include hexagonal grids, triangular grids, oblique grids, centered rectangular grids, and Archimedean grids. In some embodiments, the arrays can be irregular and even random. Each of the individual elements 20 may or may not have substantially the same shape, such as the circular shape shown.

Although flattened elements are shown and described, other shapes are possible. For example, each of the multiple surface elements 20 can have non-flat profile with respect to the intermediate layer surface 18, such as a parallelepiped, a cube, a dome, a pyramid, a trapezoid, or more generally any other shape. In this way, a first metal layer that is at a first height within the surface element 20 may have a different size than a second metal layer that is at a second height within the same surface element 20. One advantage of some embodiments over other prior art surfaces is a relaxation of fabrication tolerances. The high field region resides underneath each of the multiple surface elements 20, between the surface element 20 and a corresponding region of the ground layer 14. The surface elements also couple between themselves yielding to different resonances that could be more influenced by the distance between the different surface elements.

In more detail, each of the circular elements 20 illustrated in FIG. 2 has a respective diameter D. In some embodiments, this diameter D is the “size” of the surface elements. In the exemplary square grid, each of the circular elements 20 is separated from its four immediately adjacent surface elements 20 by a uniform grid spacing A measured center-to-center. In some embodiments, this distance A is the “spacing” between the surface elements. Embodiments, however, are not limited to a single size and a single spacing. For example, a first regular grid of surface elements with a first spacing and a first shape may be superimposed over a second regular grid of surface elements with a second spacing and a second shape. In this way, a plurality of resonances may be created.

FIG. 3 shows an alternative embodiment of a wavelength selective structure 40 including a hexagonal arrangement, or array, of surface elements 42. Each of the discrete surface elements includes a square surface element 44 having a side dimension D′. In some embodiments, this side dimension D′ is the “size” of the surface elements. Center-to-center spacing between immediately adjacent elements 44 of the hexagonal array 42 is about A′. In some embodiments this distance A′ is the “spacing” of the surface elements. For forming a resonance in the infrared portion of the electromagnetic spectrum, the diameter D′ may be, for example, between about 0.5 microns for near infrared and 50 microns for the far infrared and terahertz, understanding that any such limits are not firm and will vary depending upon such factors as the index of refraction (n), the index of absorption (k), and the thickness of layers.

Array spacing A can be as small as desired, as long as the surface elements 20 do not touch each other. Thus, a minimum spacing will depend to some extent on the dimensions of the surface feature 20. Namely, the minimum spacing must be greater than the largest diameter of the surface elements (i.e., A>D). The surface elements can be separated as far as desired, although absorption response may suffer from increased grid spacing as the fraction of the total surface covered by surface elements falls below 10%. Accordingly, in some embodiments, the total surface covered by the surface elements is greater than 10%, greater than 15% , or greater than 20%.

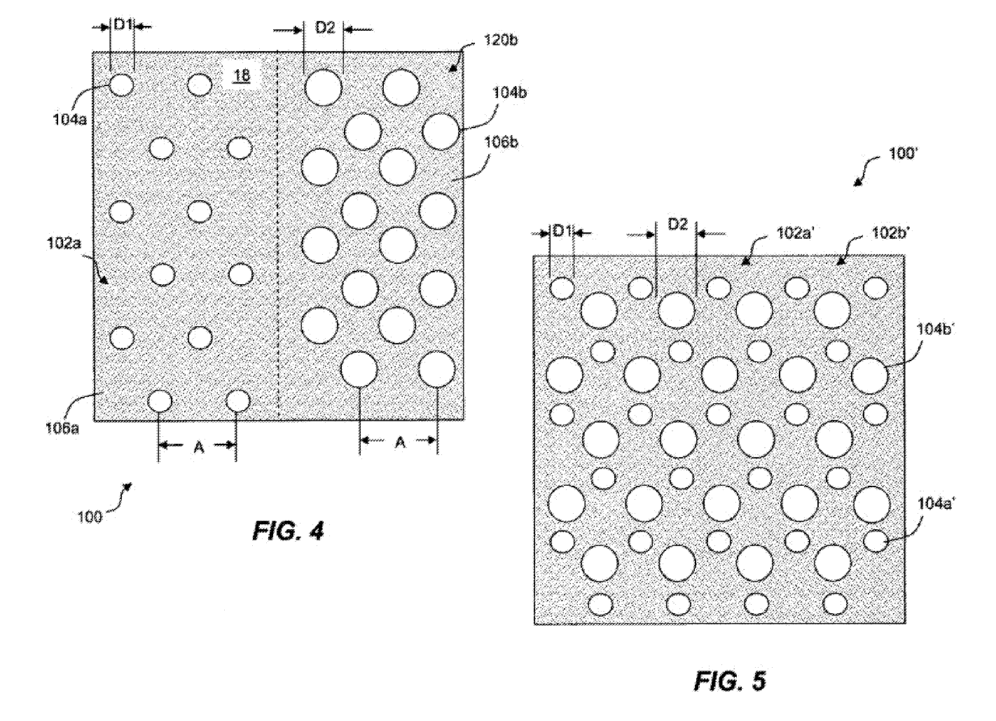

In some embodiments, more than one arrangement of uniform-sized features are provided along the same outer compound layer of a wavelength selective surface. Shown in FIG. 4 is a plan view of one such wavelength selective structure 100 having two different arrangements of surface features 102a, 102b (generally 102) disposed along the same surface. The first arrangement 102a includes a triangular array, or grid, of uniform-sized circular patches 104a, each having a diameter D1 and separated from its nearest neighbors by a uniform grid spacing A. Similarly, the second arrangement 102b includes a triangular grid of uniform-sized circular patches 104b, each having a diameter D2 and separated from its nearest neighbors by a uniform grid spacing A. Visible between the circular patches 104a, 104b is an outer surface 18 of the intermediate layer. Each of the arrangements 102a, 102b occupies a respective, non-overlapping region 106a, 106b of the intermediate layer surface 18. Except for there being two different arrangements 102a, 102b on the same surface 18, the wavelength selective structure 100 is substantially similar to the other wavelength selective structures described hereinabove. That is, the wavelength selective structure 100 also includes a ground plane 14 (not visible in this view) and an intermediate isolating layer 16 disposed between the ground plane 14 and a bottom surface of the circular patches 104a, 104b.

Each of the different arrangements 102a, 102b is distinguished from the other by the respective diameters of the different circular patches 104a, 104b (i.e., D2>D1). Other design attributes including the shape (i.e., circular), the grid format (i.e., triangular), and the grid spacing of the two arrangements 102a, 102b are substantially the same. Other variations of a multi-resonant structure are possible with two or more different surface arrangements that differ from each other according to one or more of: shape; size; grid format; spacing; and choice of materials. Size includes thickness of each of the multiple layers 14, 16, 102 of the wavelength selective structure 100. Different materials can also be used in one or more of the regions 106a, 106b. For example, an arrangement of gold circular patches 102a in one region 106a and an arrangement of aluminum circular patches 102b in another region 106b.

In operation, each of the different regions 106a, 106b will respectively contribute to a different resonance from the same wavelength selective structure 100. Thus, one structure can be configured to selectively provide a resonant response to incident electromagnetic radiation within more than one spectral regions. Such features are beneficial in IR applications in which the wavelength selective structure 100 provides resonant emission peaks in more than one IR band. Thus, a first resonant peak can be provided within a 3-5 micrometer IR band, while a second resonant peak can be simultaneously provided within a 7-14 micrometer IR band, enabling the same structure to be simultaneously visible to IR detectors operating in either of the two IR bands.

In some embodiments, the different arrangements 102a′ and 102b′ can overlap within at least a portion of the same region. One embodiment, shown in FIG. 5, includes a substantially complete overlap, in which a first arrangement 102a′ includes a triangular grid of uniform-sized circular patches 104a′ of a first diameter D1, interposed within the same region with a second arrangement 102b′ including a triangular grid of uniform-sized circular patches 104b′ of a second diameter D2. Each arrangement 102a′, 102b′ has a grid spacing of A. When exposed to incident electromagnetic radiation, wavelength selective structure 100′ will produce more than one resonant features, with each resonant feature corresponding to a respective one of the different arrangements 102a′, 102b′. As with the previous example, one or more of the parameters including: shape; size; grid format; spacing; and choice of materials can be varied between the different arrangements 102a′, 102b′.

In yet other embodiments (not shown), structures similar to those described above in relation to FIG. 4 and FIG. 5 are formed having a complementary surface. Thus, a single structure may include two or more different arrangements of through holes formed in a compound layer above and isolated from a common ground layer. One or more of the through-hole size, shape, grid format, grid spacing, thickness, and materials can be varied to distinguish the two or more different arrangements. Once again, the resulting structure exhibits at least one respective resonant feature for each of the two or more different arrangements.

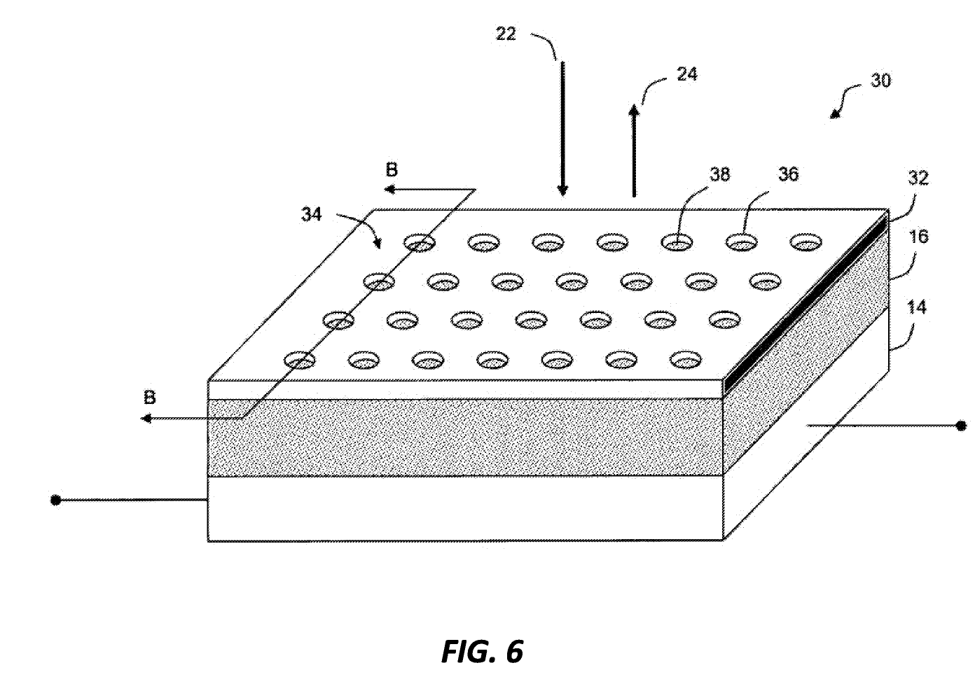

An example embodiment of an alternative family of wavelength selective structures 30 is shown in FIG. 6. The alternative wavelength selective structures 30 also include an intermediate layer 16 stacked above a ground layer 14. However, a compound layer 32, comprising at least one metal layer and at least one dielectric layer, includes a complementary feature 34. The complementary feature 34 included in the compound layer 32 defines an arrangement of through apertures, holes, or perforations.

The compound layer 32 may be formed having a uniform thickness. The arrangement of through apertures 34 includes multiple individual through apertures 36, each exposing a respective surface region 38 of the intermediate layer 16. Each of the through apertures 36 forms a respective shape bounded by a closed perimeter formed within the compound layer 32. Shapes of each through aperture 36 include any of the shapes described above in reference to the surface elements 20 (FIG. 1), 44 (FIG. 3).

Additionally, the through apertures 36 can be arranged according to any of the configurations described above in reference to the surface elements 20, 44. This includes a square grid, a rectangular grid, an oblique grid, a centered rectangular grid, a triangular grid, a hexagonal grid, and random grids. Thus, any of the possible arrangements of surface elements 36 and corresponding exposed regions of the intermediate layer surface 18 can be duplicated in a complementary sense in that the surface elements 20 are replaced by through apertures 36 and the exposed regions of the intermediate layer surface 18 are replaced by the compound layer 32.

A cross-sectional elevation view of the wavelength selective structure 10 is shown in FIG. 7A. The electrically conductive ground layer 14 has a substantially uniform thickness HG. The intermediate layer 16 has a substantially uniform thickness HD, and the compound layer 12, comprising a plurality of surface elements 20 has a substantially uniform thickness HP. The different layers 12, 14, 16 can be stacked without gaps there between, such that a total thickness HT of the resulting wavelength selective structure 10 is substantially equivalent to the sum of the thicknesses of each of the three individual layers 14, 16, 12 (i.e., HT=HG+HD+HP). A cross-sectional elevation view of the complementary wavelength selective structure 30 is shown in FIG. 7B and includes a similar arrangement of the three layers 14, 16, 32.

Both compound layer 12 and compound layer 32 include a first metal layer 21, a dielectric layer 23 and a second metal layer 25. However, embodiments are not limited by this number of metal and dielectric layers. In some embodiments, compound layer 12 and compound layer 32 may include three, four, five or more metal layers. Each metal layer may be separated by at least one dielectric layer. In some embodiments, each of the plurality of metal layers may be formed from a different metal and each dielectric layer may be formed from different dielectric materials. In other embodiments, some of the metal layers may be formed from the same metal material and some of the dielectric layers may be formed from the same dielectric material. Each of the individual metal layers 21 and 25 and the dielectric layer 23 may have a different thickness, or height, as determined by the design of the wavelength selective structure 10. Additionally, each of the layers is not limited to having a constant thickness. Any one of the layers may have a thickness that varies within each surface element or between surface elements.

In some embodiments, the intermediate isolating layer has a non-uniform thickness with respect to the ground layer. For example, the intermediate layer may have a first thickness HD under each of the discrete conducting surface elements and a different thickness, or height at regions not covered by the surface elements. It is important that a sufficient layer of insulating material be provided under each of the surface elements to maintain a design separation and to provide isolation between the surface elements and the ground layer. In at least one example, the insulating material can be substantially removed at all regions except those immediately underneath the surface elements. An example of this embodiment is illustrated in FIG. 7C, illustrating the intermediate layer 16 separated into a plurality of discrete elements directly under each surface element. In other embodiments, the isolating layer can include variations, such as a taper between surface elements. At least one benefit of the inventive design is a relaxation of design tolerances that results in a simplification of fabrication of the structures.

The thickness chosen for each of the respective layers 12, 32, 16, 14 (HP, HD, HG) and the thickness of each of metal layers 21 and 25 and dielectric layer 23 can be independently varied for various embodiments of the wavelength selective surfaces 10, 30. For example, the ground plane 14 can be formed relatively thick and rigid to provide a support structure for the intermediate and compound layers 16, 12, 32. In some embodiments, an under layer (not shown) can be provided underneath the ground layer, to provide mechanical support. The under layer may be flexible or rigid and may provide another connection to an electrode. The under layer may be, for example, a semiconductor substrate, dielectric, glass, polymer, tape, roll film, Alternatively, the ground plane 14 can be formed as a thin layer, as long as a thin ground plane 14 forms a substantially continuous electrically conducting layer of material providing the continuous ground. Preferably, the ground plane 14 is at least as thick as one skin depth within the spectral region of interest. In some embodiments, the ground plane 14 may be opaque within the spectral region of interest. Accordingly, the transmission of electromagnetic radiation through the wavelength selective structure is zero, and the sum of the absorption and the reflection from the wavelength selective structure is equal to one. In other words, absorption and reflection are complementary. Also, the absorption and emission spectrums are substantially equal. A dip in reflection translates to a peak in absorption or emission. In some embodiments, absorption is also used to detect incident radiation. Similarly, in different embodiments of the wavelength selective surfaces 10, 30, the respective compound layer 12, 32 can be formed with a thickness HP ranging from relatively thin to relatively thick. In a relatively thin embodiment, the compound layer thickness HP can be a minimum thickness required just to render the intermediate layer surface 18 opaque. Preferably, the compound layer 12, 32 is at least as thick as one skin depth within the spectral region of interest, but embodiments are not so limited. In some embodiments, each of metal layers 21 and 25 is at least as thick as one skin depth within the spectral region of interest.

Likewise, the intermediate layer thickness HD can be formed as thin as desired, as long as electrical isolation is maintained between the outer and inner electrically conducting layers 12, 32, 14. The minimum thickness can also be determined to prevent electrical arcing between the isolated conducting layers under the highest anticipated induced electric fields. Alternatively, the intermediate layer thickness HD can be formed relatively thick. The concept of thickness can be defined relative to an electromagnetic wavelength, λc, of operation, or resonance wavelength. By way of example and not limitation, the intermediate layer thickness HD can be selected between about 0.01 times λc in a relatively thin embodiment to about 0.5 times λc in a relatively thick embodiment.

Referring to FIG. 7D, a cross sectional view of a wavelength selective structure 38 includes a compound layer 12 comprising a plurality of surface features 20 disposed over ground plane 14, with an intermediate isolating layer 16 disposed between the surface features 20 and the ground plane 14. The wavelength selective structure 38 also includes a second intermediate layer 39 disposed between a top surface 18 of the isolating layer and a bottom surface of the surface features 20. The second layer 39 is also an isolating material, such that the individual surface features 20 remain discrete and electrically isolated from each other with respect to a non-time-varying electrical stimulus. For example, the second intermediate layer 39 can be formed from a dielectric material chosen to have material properties n, k different than the material properties of the first intermediate layer 16. Any dielectric material can be used including any of the dielectric materials described herein. Alternatively or in addition, the second intermediate layer 39 can be formed from a semiconductor material. Any semiconductor can be used, including those semiconductor and semiconductor compounds described herein, provided that the semiconductor includes an electrically insulating mode. More generally, a fourth layer having physical properties described above in relation to the second intermediate layer 39 can be provided between any of the three layers 14, 16, 20 of the wavelength selective structure 38.

Referring to FIG. 7E, a cross sectional view of a wavelength selective structure 10 includes a compound layer 12 comprising a plurality of surface features 20 disposed over ground plane 14, with an intermediate isolating layer 16 disposed between the surface features 20 and the ground plane 14. In this particular embodiment, each surface feature 20 includes a first metal layer 21 and a second metal layer 25, each metal layer having a different characteristic size. For example, as illustrated, the first metal layer 21 is a circular patch with a first diameter, D1, and the second metal layer 25 is a circular patch with a second diameter, D2. The dielectric layer 23 is shown having the same diameter, D1, as the first metal layer 21. However, in other embodiments, the dielectric layer 23 may have a diameter the same as the second diameter, D2. In other embodiments, the dielectric layer 23 may have a diameter, D3, less than the first diameter, D1, and greater than the second diameter, D2 (i.e., D2<D3<D1). In addition to having metal layers of different sizes within a single surface feature, in some embodiments, the shape of the first metal layer 21 may be different than the shape of the second metal layer 25. Additionally, while FIG. 7E illustrates surface features that are patches, when holes are used as surface features a similar configuration may be implemented such that the metal layers of the compound layer that is not a surface feature may have different sizes, resulting in a particular hole having different sized at different depths within the compound layer.

The wavelength selective surfaces 10, 30, 38 can be formed using standard semiconductor fabrication techniques. Thin structures can be obtained using standard fabrication techniques on a typical semiconductor substrate, which can also be transferred to other type of substrates, either flexible or rigid, such as plastics, film roll, glass, or tape. In some embodiments, the fabrication may be followed by a release step, wherein the thin structure is released from the substrate. One such technique is referred to as back-side etching, in which a sacrificial layer is removed underneath the device formed upon the semiconductor substrate. Removal of the sacrificial layer releases a thin-film device from the substrate. Alternatively, the sacrificial layer can be etched from the front side, in a technique referred as—front-side release, releasing the thin-film device from the substrate. An under layer might be left in contact with the bottom ground layer to offer mechanical support and other means for external triggering.

Alternatively or in addition, the wavelength selective surfaces 10, 30, 38 can be formed using thin film techniques including vacuum deposition, chemical vapor deposition, and sputtering. In some embodiments, the compound layer 12, 32 can be formed using printing techniques. The surface features can be formed by providing a continuous electrically conductive surface layer and then removing regions of the surface layer to form a plurality of metal layers of the surface features. Regions can be formed using standard physical or chemical etching techniques. Alternatively or in addition, the surface features can be formed by laser ablation, removing selected regions of the conductive material from the surface, or by nano-imprinting or stamping, roll-to-roll printing or other fabrication methods known to those skilled in the art.

Referring to FIG. 8A a cross-sectional elevation view of an alternative embodiment of a wavelength selective structure 50 is shown having an over layer 52. Similar to the embodiments described above, the wavelength selective structure 50 includes a compound layer 12 having an arrangement of surface elements 20 (FIG. 1) disposed at a height above a ground layer 14 and separated therefrom by an intermediate layer 16. The over layer 52 represents a fourth layer, or superstrate 52 provided on top of the compound layer 12.

The over layer 52 can be formed having a thickness HC measured from surface 18 of the intermediate layer 16 to the top surface of the over layer 52 opposite the surface 18 of the intermediate layer 16. In some embodiments, the over layer 52 thickness HC is greater than thickness of the compound layer 12 (i.e., HC>HP). The over layer 52 can be formed with uniform thickness to provide a planar external surface. Alternatively or in addition, the over layer 52 can be formed with a varying thickness, following a contour of the underlying compound layer 12.

An over layering material 52 can be chosen to have selected physical properties (e.g., k, n) that allow at least a portion of incident electromagnetic radiation to penetrate into the over layer 52 and react with one or more of the layers 12, 14, and 16 below. In some embodiments, the overlying material 52 is substantially optically transparent in the vicinity of the primary absorption wavelength, to pass substantially all of the incident electromagnetic radiation. For example, the overlying material 52 can be formed from a glass, a ceramic, a polymer, or a semiconductor. The overlaying material 52 can be applied using any one or more of the fabrication techniques described above in relation to the other layers 12, 14, 16 in addition to painting and/or dipping.

In some embodiments, the over layer 52 provides a physical property chosen to enhance performance of the wavelength selective structure in an intended application. For example, the overlaying material 52 may have one or more optical properties, such as absorption, refraction, and reflection. These properties can be used to advantageously modify incident electromagnetic radiation. Such modifications include focusing, de-focusing, and filtering. Filters can include low-pass, high-pass, band pass, and band stop. In other embodiments the properties of the over layer can be tuned dynamically to tune the location, amplitude and/or bandwidth of one or more resonances. By way of example and not limitation, the over layer can be tuned to be electrically conductive and short the surface elements and destroy the resonance, and then it can be tuned to be electrically insulating and allow for at least one or more of the resonances to take effect. Accordingly, in some embodiments, the over layer may be formed from a semiconductor material. In this case the over layer acts as a tunable shutter for the device. This could be used for pulsing applications or scene generation, or any other suitable application. In other embodiments, the over layer can interact with substances in its vicinity and change its properties that in turn would influence the location, amplitude and/or bandwidth. The interaction of the over layer with the environment can be, but is not restricted to, electrical, thermal, chemical, biological, nuclear or physical. Interaction of the over layer with its environment and its subsequent influence of the resonances of the device can impart detection and sensing capabilities to the device that are not only electromagnetic radiation, but expanded the capability to but not restricted to chemical, biological, nuclear and physical detecting and sensing.

The overlaying material 52 can be protective in nature allowing the wavelength selective structure 50 to function, while providing environmental protection. For example, the overlaying material 52 can protect the compound layer 12 from corrosion and oxidation due to exposure to moisture. Alternatively or in addition, the overlaying material 52 can protect either of the exposed layers 12, 16 from erosion due to a harsh (e.g., caustic) environment. Such harsh environments might be encountered routinely when the wavelength selective structure is used in certain applications. At least one such application that would benefit from a protective overlaying material 52 would be a marine application, in which a protective over layer 52 would protect the compound layer 12 or 32 from corrosion.

In another embodiment shown in FIG. 8B, a wavelength selective structure 60 includes an overlying material 62 applied over a compound layer 32 defining an arrangement of through apertures 34, including individual aperture 36 (FIG. 6). The overlying material 62 can be applied with a maximum thickness HC measured from the surface 18 of intermediate layer 16 to be greater than the thickness of the compound layer 32 (i.e., HC>HP). The overlaying material 62 again can provide a planar external surface or a contour surface. Accordingly, a wavelength selective structure 60 having apertures 34 defined in a compound layer 32 is covered by an overlying material 62. The performance and benefits of such a structure are similar to those described above in relation to FIG. 8A.

In another embodiment shown in FIG. 8C, the overlying material 52 of the wavelength selective surface 50 does not cover the tops of the compound layer 12, but partially fills the gaps between the surface features such that it covers the intermediate layer 16 and the sides of at least a portion of the surface features. In this embodiments, the thickness of the overlying material 52 is less than the thickness of the compound layer (i.e., HC<HP). While FIG. 8C illustrates the overlying material 52 filling gaps between surface features that are patches, a similar overlying layer may be used with surface features that are holes in the compound layer. When the surface features are holes, the overlying material 52 fills the holes, which are the surface features.

In another embodiment shown in FIG. 8D, the overlying material 52 of the wavelength selective surface 50 forms a conformal layer that conforms to the shape of the top surface of the wavelength selective surface 50. In this way, the top surface of the overlying material 52 is not flat, but becomes raised at the location of the surface features. While FIG. 8D illustrates the overlying material 52 covering surface features that are patches, a similar overlying layer may be used with surface features that are holes in the compound layer. When the surface features are holes, the overlying material 52 fills the holes and the overlying layer becomes raised at the locations where the surface features are not present.

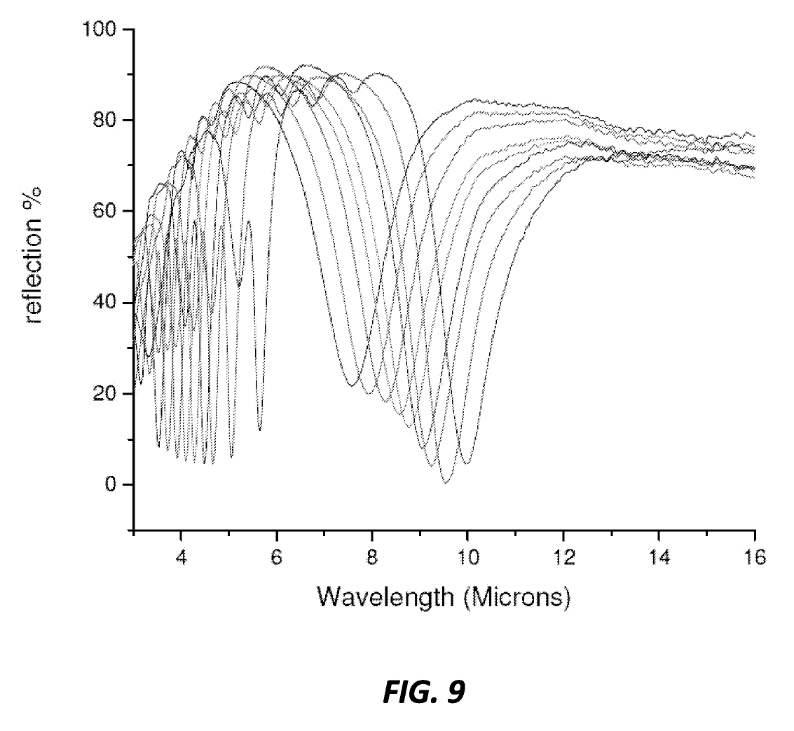

FIG. 9 illustrates example reflectivity versus wavelength response curves of a plurality of different wavelength selective surfaces according to some embodiments. Each wavelength selective structure used a different size surface feature arranged in a periodic array with different periodicities. The response curves are achieved by exposing a wavelength selective structure comprising a compound layer with a single metal layer to incident electromagnetic radiation 22 (FIG. 1) within a band including a resonance. As shown, the reflectivity to incident electromagnetic radiation varies within the range of 0% to 100%. Each individual curve exhibits two resonances with low reflection (and, therefore, high absorption). One resonance is primarily based on the periodicity of the surface elements and the other is primarily based on the size of the surface features. By tuning these parameters, properties of the resonances, such as bandwidth, magnitude, and central frequency can be adjusted.

Results supported by both computational analysis of modeled structures and measurements suggest that the higher wavelength resonance corresponds to a maximum dimension of the surface elements (e.g., a diameter of a circular patch D, or a side length of a square patch D′). As the diameter of the surface elements is increased, the wavelength of the higher wavelength resonance also increases. Conversely, as the diameter of the surface elements is decreased, the central wavelength associated with the higher wavelength resonance decreases. If at least one of the materials used within the structure exhibits material-specific resonances in the waveband of interest, these material-specific resonances could interact with the structure resonances and modify the structure resonances and/or the material resonances.

Similarly, results supported by both computational analysis of modeled structures and measurements suggest that the wavelength associated with the lower wavelength resonance corresponds at least in part to a center-to-center spacing of the multiple surface elements. As the spacing between surface elements 20 in the arrangement of surface elements 12 is reduced, the wavelength of the lower wavelength resonance decreases. Conversely, as the spacing between the arrangement of surface elements 12 is increased, the wavelength of the lower wavelength resonance increases.

In general, the performance may be scaled to different wavelengths according to the desired wavelength range of operation. Thus, by scaling the design parameters of the wavelength selective structures as described herein, resonant performance can be obtained within any desired region of the electromagnetic spectrum. Resonant wavelengths can range down to visible light and even beyond into the ultraviolet and X-ray. At the other end of the spectrum, the resonant wavelengths can range into the terahertz band (e.g., wavelengths between about 1 millimeter and 100 microns) and even up to radio frequency bands (e.g., wavelengths on the order of centimeters to meters). Operation at the shortest wavelengths will be limited by available fabrication techniques. Current techniques can easily achieve surface feature dimensions to the sub-micron level. It is conceivable that such surface features could be provided at the molecular level using currently available and emerging nanotechnologies. Examples of such techniques are readily found within the field of molecular self-assembly.

The reflectivity curves illustrated in FIG. 9 show the results for a compound layer comprising a single metal layer. When multiple metal layers are utilized, additional resonances will be introduced to the reflectivity curves.

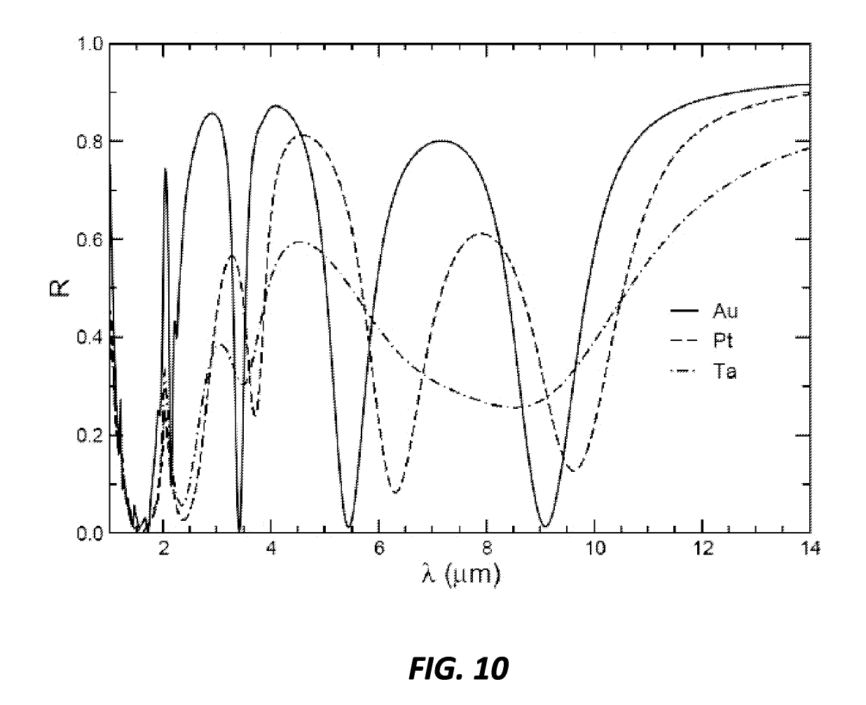

FIG. 10 illustrates reflection curves associated with a wavelength selective structure similar to the one illustrated in FIG. 1, where a square array of circular patches are located above an electrically conductive ground plane. The patches comprise two different metal layers. The metal used is varied to show the effect changing the metal has on the resonances. In FIG. 10, the solid curve illustrates the reflectivity curve when surface elements include gold, the dashed curve illustrates the reflectivity curve when surface elements include platinum, and the dashed-dotted line illustrates the reflectivity curve when surface elements include tantalum.

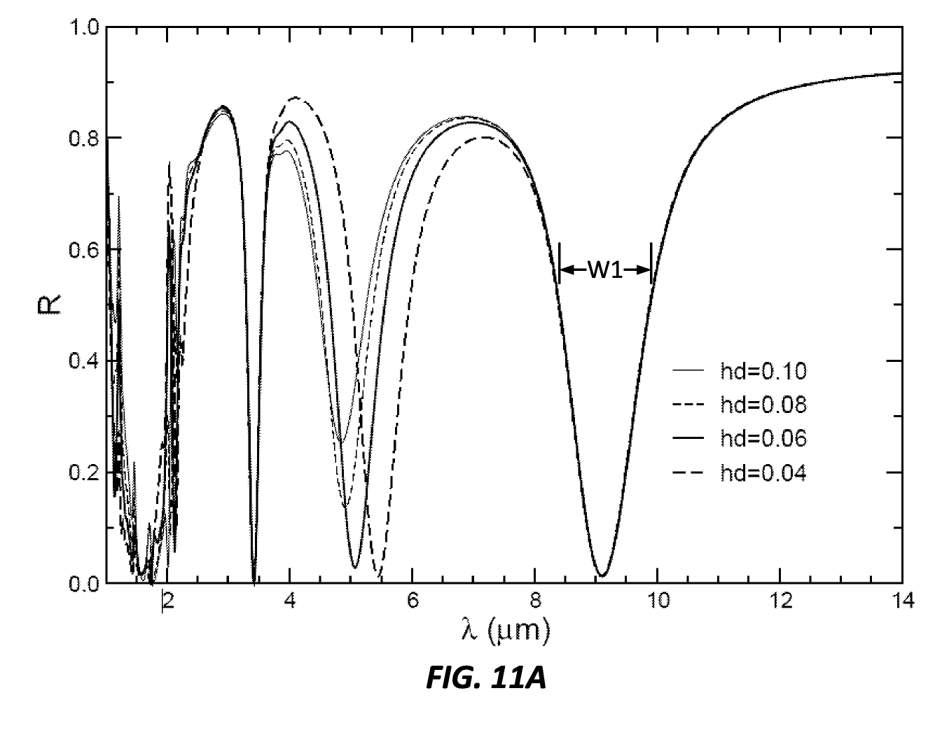

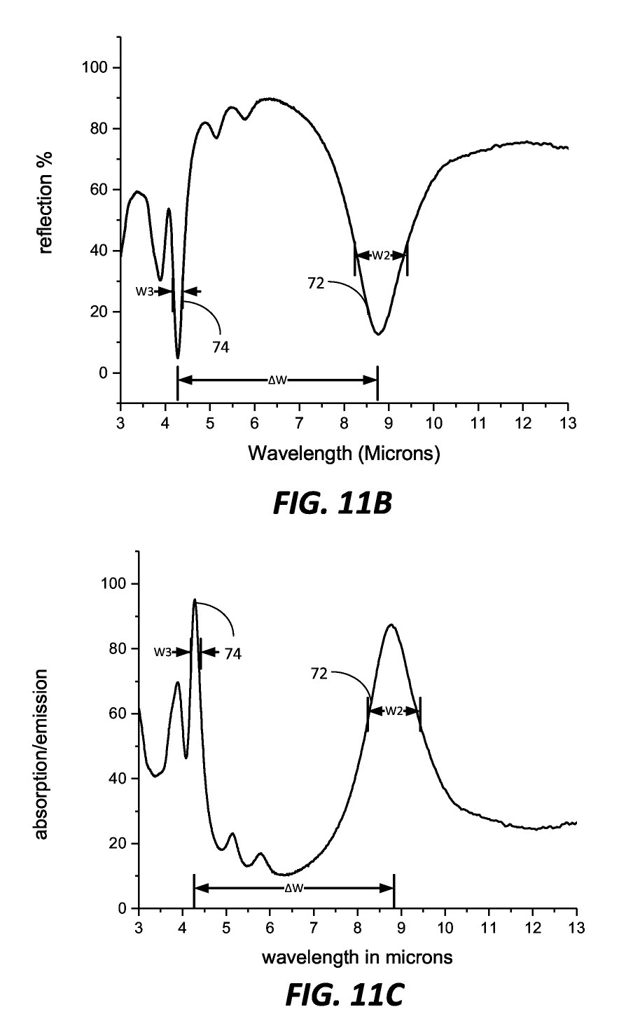

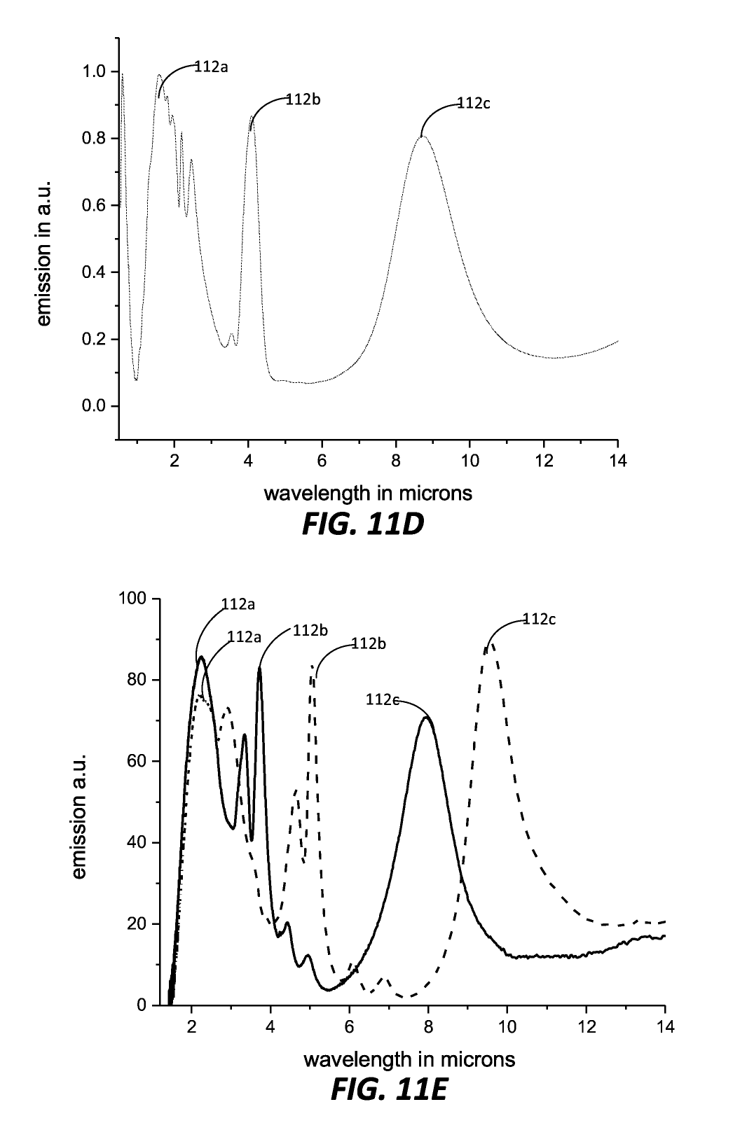

FIG. 11A illustrates reflection curves associated with a wavelength selective structure similar to the one illustrated in FIG. 1, where a square array of circular patches are located above an electrically conductive ground plane. The patches comprise two different metal layers. The thickness of the dielectric intermediate layer is varied to show the effect changing the thickness of the dielectric intermediate layer has on the resonances. The reflectivity curve is obtained by exposing a wavelength selective device 10 (FIG. 1) constructed in accordance with the principles of the present invention to incident electromagnetic radiation 22 (FIG. 1) within a band including a resonance. As shown, the reflectivity to incident electromagnetic radiation varies according to the curve within the range of 0% to 100%. Each resonance has an associated characteristic wavelength (e.g., central wavelength), amplitude and bandwidth (e.g., the right most band has a bandwidth, W1, which is approximately 1.5 micrometers. The bandwidth may be determined in any suitable way, e.g., the full-width-half-maximum (FWHM).

Results supported by both computational analysis of modeled structures and measurements suggest that the resonant wavelength associated with one or more of the resonance bands corresponds to a maximum dimension of the electrically conductive surface elements (e.g., a diameter of a circular patch D, or a side length of a square patch D′). As the diameter of the surface elements is increased, the wavelength of one or more of the resonance band also increases. Conversely, as the diameter of the surface elements is decreased, the wavelength of the resonance band 72 decreases. For example, the primary resonance on the far right of FIG. 11A may be tuned using this technique.

FIG. 11B illustrates a reflectivity response curve similar to FIG. 11A, but for a dual band device. FIG. 11C illustrates a corresponding absorption/emission curve for the same device. The absorption/emission curve in this particular embodiment is the reverse of the reflectivity curve because the sum of the reflectivity (R) transmission (T) and the absorption (A) must equal unity (R+T+A=1), Absorption equals emission (E), A=E, and if T=0, if the structure is opaque, than A=1-R. The structure is not always completely opaque, and in some embodiments transmission doesn't have to be zero. The second and much more pronounced dip 72 corresponds to a primary resonance of the underlying wavelength selective device. As a result of this resonance, a substantial portion of the incident electromagnetic energy 22 is absorbed by the wavelength selective surface 10. A measure of the spectral width of the resonance response 70 can be determined as a width in terms of wavelength normalized to the resonant wavelength (i.e., Δλ/λc or dλ/λc). Preferably, this width is determined at full-width-half-maximum (FWHM). For the exemplary curve, the width of the absorption band 72 at FWHM is less than about 1.25 microns with an associated resonance frequency of about 8.75 microns. This results in a spectral width, or dλ/λc of about 0.14. The width of the absorption band 74 at FWHM is less than about 0.25 microns with an associated resonance frequency of about 4.25 microns. This results in a spectral width, or dλ/λc of about 0.06. Generally, a dλ/λc value of less than about 0.1 can be referred to as narrowband. Thus, the exemplary resonance 74 is representative of a narrowband resonance band. In other embodiments the resonances can be broadband or a combination of narrow band and broadband. In other embodiments at least one resonance can be formed out of one, two or more resonances very closely spaced. In other embodiments at least one resonance can be formed out of one, two or more resonances spaced closely together, e.g., such that the bandwidth of each resonance is wider than the wavelength separation between resonances. The absorption bands are equivalent to emission bands, when the device is emitting instead of absorbing/detecting/sensing.

Results supported by both computational analysis of modeled structures and measurements suggest that the resonant wavelength associated with the primary resonance response 72 corresponds to a maximum dimension of the electrically conductive surface elements (e.g., a diameter of a circular patch D, or a side length of a square patch D′). As the diameter of the surface elements is increased, the wavelength of the primary absorption band 72 also increases. Conversely, as the diameter of the surface elements is decreased, the wavelength of the primary absorption band 72 also decreases. The interdependence between the main resonance location and the surface elements size can be influenced, limited or enhanced by intrinsic material resonances of at least one of the materials used in the formation of the structure.

The first, dip 74 in reflectivity corresponds to a secondary absorption band of the underlying wavelength selective surface 10. Results supported by both computational analysis of modeled structures and measurements suggest that the wavelength associated with the secondary absorption band 74 corresponds at least in part to a center-to-center spacing of the multiple electrically conductive surface elements. As the spacing between surface elements 20 in the arrangement of surface elements 12 is reduced, the wavelength of the secondary absorption band 74 decreases. Conversely, as the spacing between the arrangement of surface elements 12 is increased, the wavelength of the secondary absorption band 74 increases. The secondary absorption band 74 is typically less pronounced than the primary absorption band 72 such that a change in reflectivity AR can be determined between the two absorption bands 74, 72. A difference in wavelength between the primary and secondary resonance bands 72, 74 is shown as ΔW.

The intrinsic material resonances of at least one of the materials used in the formation of the structure can interfere with at least one of the resonances of the structure, affecting its location, bandwidth and efficiency. In turn at least one of the resonances of the structure can influence the intrinsic material resonances of at least one of the materials used in the formation of the structure.

In general, the performance may be scaled to different wavelengths according to the desired wavelength range of operation. Thus, by scaling the design parameters of any of the wavelength selective surfaces as described herein, resonant performance can be obtained within any desired region of the electromagnetic spectrum. Resonant wavelengths can range down to visible light and even beyond into the ultraviolet and X-ray. At the other end of the spectrum, the resonant wavelengths can range into the terahertz band (e.g., wavelengths between about 1 millimeter and 100 microns) and even up to radio frequency bands (e.g., wavelengths on the order of centimeters to meters). Operation at the shortest wavelengths may be limited by available fabrication techniques. Current techniques can easily achieve surface feature dimensions to the sub-micron level. It is conceivable that such surface features could be provided at the molecular level using currently available and emerging nanotechnologies. Examples of such techniques are readily found within the field of molecular self-assembly.

FIG. 11D illustrates an absorption or emission response curve similar to FIG. 11A, but for a triple band device. A first resonance 112a occurs at about 2.0 μm and a second resonance 112b occurs at about 4.0 μm and a third resonance 112c occurs at about 9.0 μm. FIG. 11E illustrates a similar absorption or emission response curve (solid line) with variation due to one or more of the material properties, the size of the surface features, and periodicity of the surface features (shown as a dashed line). A first resonance 112a occurs at about 2.0 μm and does not shift in wavelength due to variation, but changes in amplitude. A second resonance 112b occurs at about 4.0 μm and, after variation of one or more parameters, shifts to about 5.0 μm. A third resonance 112c occurs at about 8.0 μm and shifts to about 9.5 μm after variation of one or more parameters. The third resonance 112c also narrows in bandwidth and shifts to a higher amplitude after variation.

In the above curves, different selection of design parameters results in differing response curves. For example, the primary absorption/emission band 72 of FIG. 11B-C occurs at about 8.75 microns, with wavelength range at FWHM of about 1.25 microns. This results in a spectral width Δλ/λc of about 0.14. A spectral width value Δλ/λc greater than 0.1 can be referred to as broadband. Thus, the underlying wavelength selective device 10 can also be referred to as a broadband structure.

One or more of the physical parameters of the wavelength selective device 10 can be varied to control reflectivity and absorption-emission response of a given wavelength selective surface. For example, the thickness of one or more layers (e.g., surface element thickness Hp, dielectric layer thickness HD, and over layer thickness HC) can be varied. Alternatively or in addition, one or more of the materials of each of the different layers can be varied. For example, the dielectric material can be substituted with another dielectric material having a different n and k values. The presence or absence of an over layer 52 (FIG. 8A), as well as the particular material selected for the over layer 52 can also be used to vary the reflectivity or absorption-emission response of the wavelength selective surface. Similar performance changes may be achieved by changing the material of the ground plane, change the dimension D of the surface elements, or by changing the shape of the surface elements.

In a first example, a wavelength selective surface includes an intermediate layer formed with various diameters of surface patches. The wavelength selective surface includes a triangular array of round aluminum patches placed over an aluminum film ground layer. The various surfaces are each formed with surface patches having a different respective diameter. A summary of results obtained for the different patch diameters is included in Table 1. In each of these exemplary embodiments, the patch spacing between adjacent patch elements was about 3.4 microns, and the thickness or depth of the individual patches and of the ground layer film were each about 0.1 micron. An intermediate, dielectric layer having thickness of about 0.2 microns was included between the two aluminum layers. It is worth noting that the overall thickness of the wavelength selective surface is about 0.4 microns—a very thin material. The exemplary dielectric has an index of refraction of about 3.4. Table 1 includes wavelength values associated with the resulting primary absorptions. As shown, the resonant wavelength increases with increasing patch size.

TABLE 1
Primary Absorption/Emission Wavelength Versus Patch Diameter

| Patch Diameter | Resonant Wavelength (λc) |
|---|---|
| 1.25 μm | 4.1 μm |
| 1.75 μm | 5.5 μm |
| 2.38 μm | 7.5 μm |
| 2.98 μm | 9.5 μm |

In another example, triangular arrays of circular patches having a uniform array spacing of 3.4 microns and patch diameter of 1.7 microns are used. A dielectric material provided between the outer conducting layers is varied. As a result, the wavelength of the primary absorption shifts. Results are included in Table 2.

TABLE 2
Resonance Versus Dielectric Material

| Dielectric material | Resonant Wavelength (λc) |
|---|---|
| Oxide | 5.8 μm |
| Nitride | 6.8 μm |
| Silicon | 7.8 μm |

In some embodiments, the response of a wavelength selective device may be within a portion of the IR spectrum. When combined with a thermal source of radiation, wavelength selective devices according to the principles of the present invention produce a resonant response in emissivity as determined at least in part to one or more physical aspects of the underlying device. As described in U.S. Pat. No. 7,119,337, incorporated herein by reference in its entirety, a narrowband thermal source can be tuned to an absorption band of a target gas. A sample of a substance, such as a gas is illuminated with the narrowband thermal source. A portion of the emitted spectrum is detected after propagating through the sample. When the target gas is present, the detected radiation will be substantially less due to absorption by the gas.

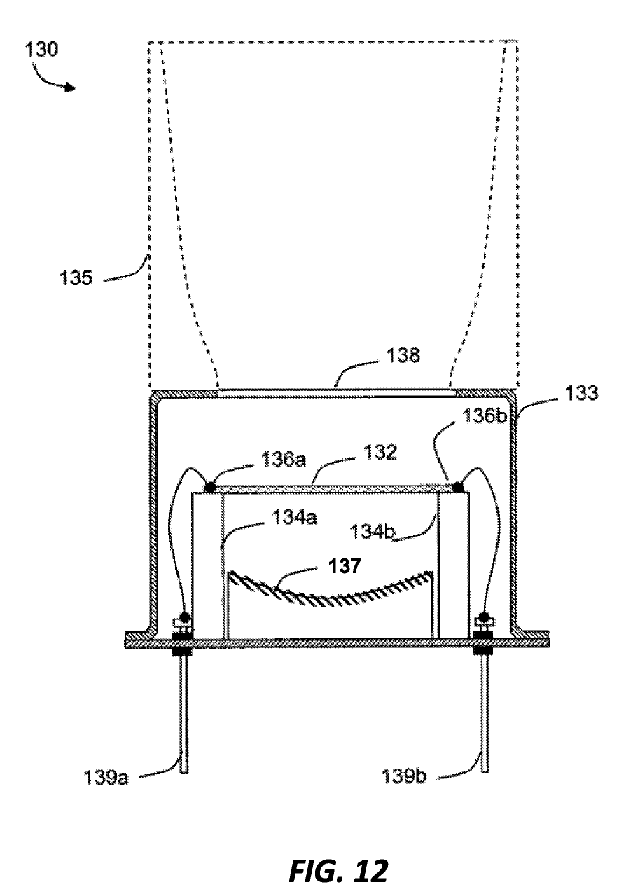

Referring to FIG. 12, a thermal source 130 includes a narrowband IR source 132 within an electrical device package 134. In an exemplary embodiment, the IR source 132 is a horizontal wavelength selective structure prepared in accordance with the device of FIG. 1, including a compound layer that includes a plurality of surface features above a ground plane separated by an intermediate thin-film layer of insulating material. The ground plane is provided with a finite conductivity having a real resistive component. The thin film structure 132 is suspended in a bridge configuration between a pair of vertical support members 134a, 134b. Electrical terminals 136a, 136b are used to inject an electrical current into the ground plane of the emission device 132 to produce thermal energy through a process referred to as Joule heating, or equivalently as I2R heating. In other embodiments, the IR source is a coiled filament including a wavelength selective structure.

The device package 133 may include a sealed housing, such as a TO-8 or TO5 or LCC or others transistor used in standard process equipment, to isolate the IR source 132 from the environment. The package 133 includes at least one window 138 substantially aligned with an emission surface of the IR source 132, such that IR emissions can exit the package 133 to interact with the environment. The package 133 may contain room air or a gas of choice at a given pressure such as, by way of example and not limitation, argon. In some embodiments, the room air and/or gas of choice may be hermetically sealed to contain room air Alternatively, the package 133 may be sealed to reduce the presence of gas such that the package 133 contains vacuum. The window 138 may include one or more optical properties including reflection, absorption, and transmission. In some embodiments, the device 130 includes a feature, such as the collar 135 shown providing a smooth reflective surface disposed around the IR source 132 and adapted to collect radiation emitted from the surface to selectively direct IR emissions within a preferred direction. The collar 135 can take various shapes to provide collimation, focusing or divergence of the radiation emitted and can have various degrees of reflectivity. Alternatively or in addition, a reflective member 137 is provided on the floor of the package, underneath the suspended IR source 132 (e.g., on an interior surface of the header of the transistor) to reflect emission from a back side of the IR source 132 toward the window 138. Additionally, the package 133 includes one or more electrical leads 139a, 13b that can be used to inject an electrical current to drive the IR source 132. More generally, the IR source 132 includes any of the thin film wavelength selective structures described herein combined with a thin film thermal source—which can be, for example, the ground plane.

In some embodiments, a wavelength selective structure, such as the IR source 132 above, includes additional layers, including a different respective insulating layer on each surface of the ground layer. Each insulating layer can have a respective arrangement of electrically conductive surface elements. Such a device is bidirectional in that it provides a respective reflectivity-absorption and emission profile on either side of the ground plane. A resonant performance of each of the different sides is independently controllable according to selected design parameters. In some embodiments, the design parameters of each side of the device are substantially identical yielding similar resonances. Alternatively, the design parameters of each side of the device are substantially different yielding different resonances.

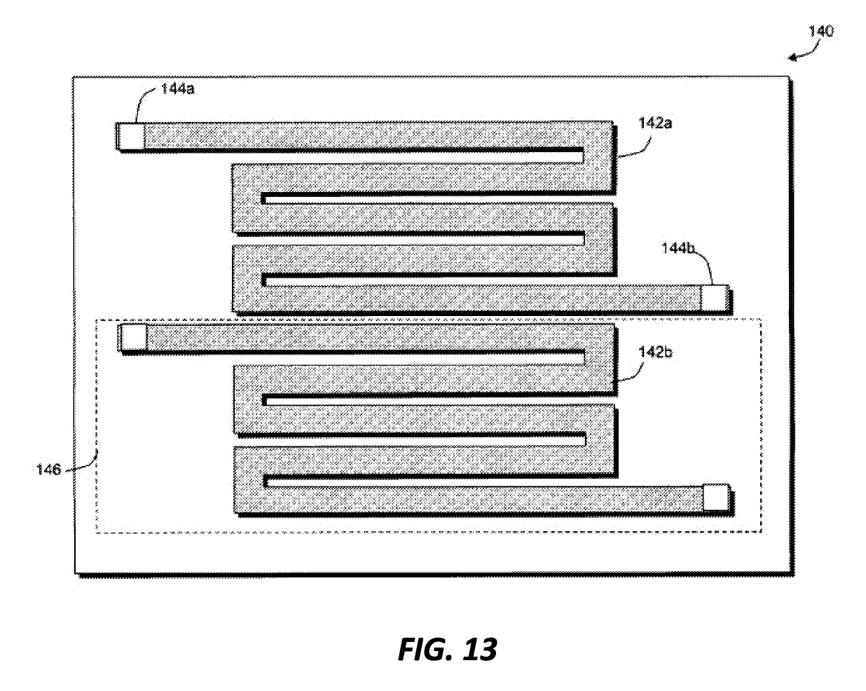

Referring to FIG. 13, an IR source 140 can include a first IR source 142a formed in a ribbon or filament configuration. The first filament 142a can be formed in a serpentine shape, as shown, having electrical terminals 144a, 144b at either end. The electrical current can be applied between the terminals 144a, 144b causing a resistive ground plane to heat.

A second filament 142b can be provided within the same IR source 140. Preferably, the second filament 142b is constructed similar to the first 142a. In some embodiments, the second filament 142b is used as a detector, detecting a reflected return of IR emissions from the first filament 142a. In some embodiments, the second filament 142b is covered, or “blinded” by a screen 146. Thus, the second filament 142 shielded by the screen 146 does not respond to received IR from outside the package, but is allowed to respond to other environmental and device-dependent effects, such as ambient temperature and long-term variations in performance due to aging of the device. When formulated from the same material, the second filament 142b can be used as a reference to compare response measured on the first filament 142a. Thus, effects due to ambient temperature, gases and long-term aging can be effectively removed from measurements obtained from the first.

In general, drive and readout schemes using a microprocessor controlled, temperature-stabilized driver can be used to determine resistance from drive current and drive voltage readings. That information shows that incidental resistance (temperature coefficient in leads and packages and shunt resistors, for instance) do not overwhelm the small resistance changes used as a measurement parameter.

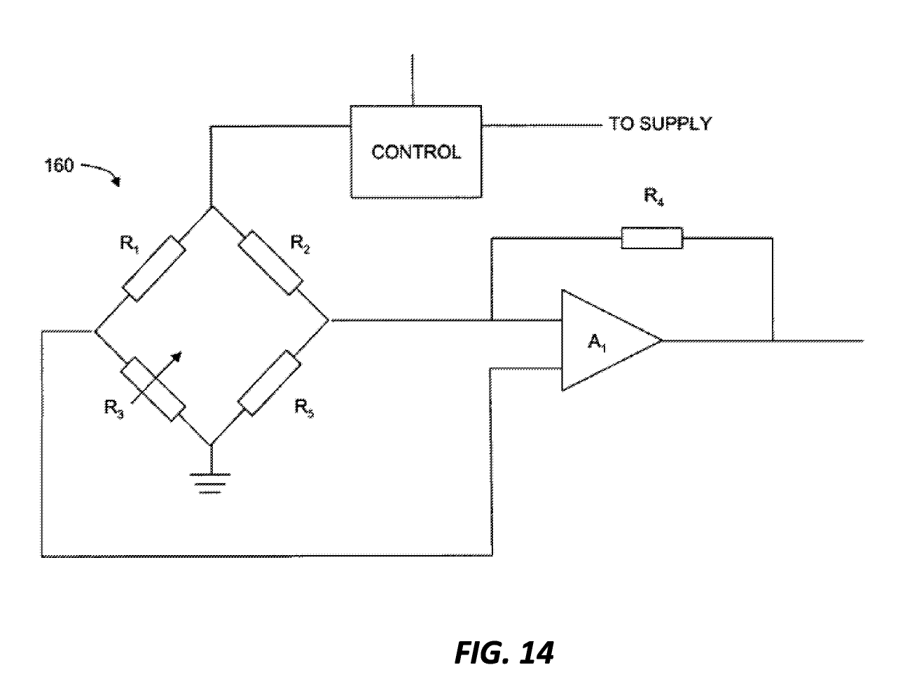

For embodiments using a second detector for reference, the devices can be configured in a balanced bridge. Referring to FIG. 14, a Wheatstone bridge drive circuit 160 is shown. The Wheatstone bridge is a straightforward analog control circuit used to perform the function of measuring small resistance changes in a detector. It is very simple, very accurate, quite insensitive to power supply variations and relatively insensitive to temperature. The circuit is “resistor” programmable but depends for stability on matching the ratio of resistors. In one form, an adjacent “blind” detector element—an identical bolometer element filtered at some different waveband—is used as the resistor in the other leg of the bridge, allowing compensation for instrument and component temperatures and providing only a difference signal related to infrared absorption in the target gas.

In some embodiments, a wavelength selective emission device can be operated as both a source and a detector. For example, the emission device is heated using a thermal source, such as a resistive filament excited by an electrical current. The infrared radiation excites the arrangement of surface elements establishing a resonant coupling of the surface elements to other surface elements and to the ground plane. The result is an IR emission having a preferred spectra width (e.g., narrowband or wideband, depending upon the selection of design parameters). Heat is then removed from the source and the emission device is allowed to cool. The device can be used as a bolometer also detecting IR from an external environment or its own self-emission. The minimum duration of time between heating and cooling is limited by the thermal relaxation of the emission device. Preferably the thin film device is extremely thin, on the order of 10 μm or less, providing a very low thermal mass. Such thin film devices are capable of rapid cooling and can support thermal cycles approaching 1 to 200 Hz or even greater.

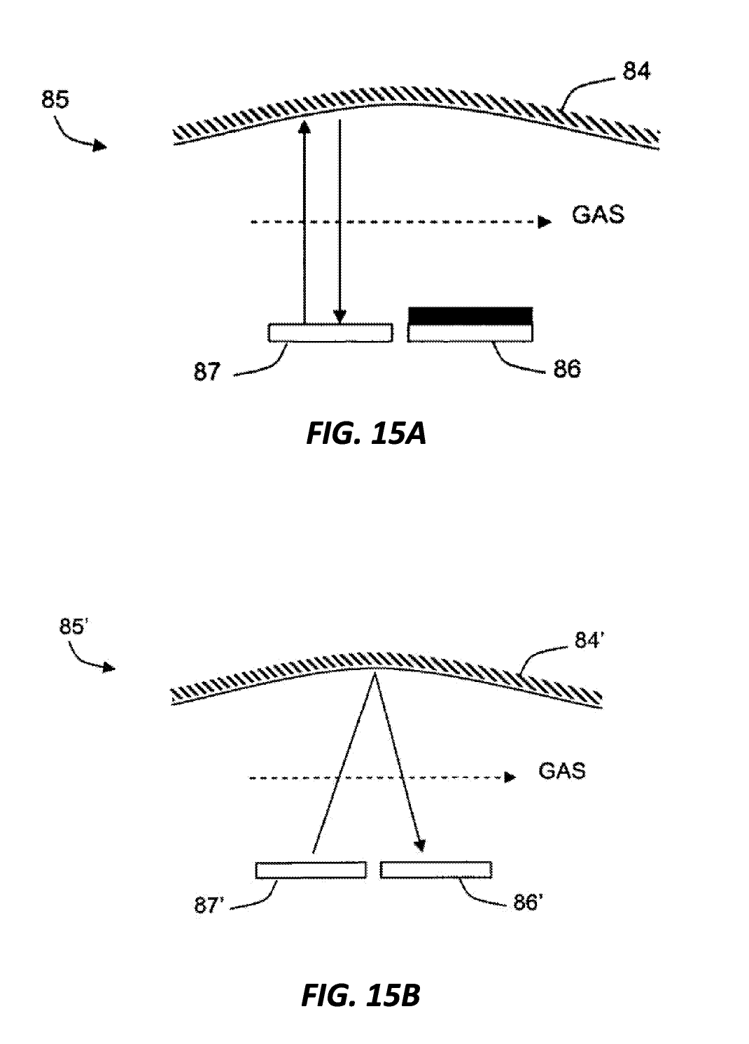

Referring to FIG. 15A, one embodiment of a target material detector 85 provides an IR source including wavelength selective emission device 87 as described herein. Thus, the emission device 87 emits IR radiation at a wavelength selected to coincide with an absorption band of a target material, such as a gas. The resonant emission device 87 is aligned to emit radiation toward a target material (e.g., a gas). A reflecting surface such as a retro-reflective minor, or a spherical mirror 84, is positioned opposite the emission device 87 (e.g., at a radial center of the spherical minor), leaving a channel there between to accommodate a sample of the gas to be inspected for presence of the target component. In operation, radiation emitted from the emission device 87 passes through the gas sample toward the mirror 84. That portion of emitted radiation not absorbed by the sample gas reflects off of the mirror 84 and travels back toward the emission device 87 traversing the sample gas once again. When configured to act as an absorber and a receiver, the emissive device 87 detects the amount of received energy at the resonant wavelength. The detected value can be compared to the emitted value to determine an absorption value indicative of the target gas.

When a wavelength selective structure having multiple resonances is used, each of the multiple resonances can be individually tuned to a respective one of more than one target components. Such a device 85 is capable of detecting a preferred combination of different target elements. When all of the two or more target elements are present, absorption of the multi-resonant emissions result in a minimum detected return, as all of the multiple resonant emissions will endure absorption. However, when one or more of the two or more target elements are absent from the mixture, at least one of the corresponding resonant radiation emissions will suffer little or no absorption yielding a non-minimum detected return.

In some embodiments, a second emission device 86 is provided in the vicinity of the first 87. The first emission device 87 is tuned to the gas, while the second emission device 86 is tuned to a different wavelength, chosen to be outside the absorption band of any target elements in the gas. The return from the second emission device 86 can be used to measure other effects, such as ambient temperature changes and long-term changes due to device degradation. Results from the second emission device 86 can be combined with results from the first device 87, using techniques described herein, to effectively remove these secondary effects.

Referring to FIG. 15B, another embodiment of a reflective gas sensor 85′ using a separate emission device 87′ and detection device 86′. A mirror 84′ is disposed within the optical path between the emission device 87′ and the detection device 86′. The sample material is also disposed between the optical path, such that emitted radiation traverses the sample, such that absorption by a target element will bet evident by a reduced return at the detector 86′.

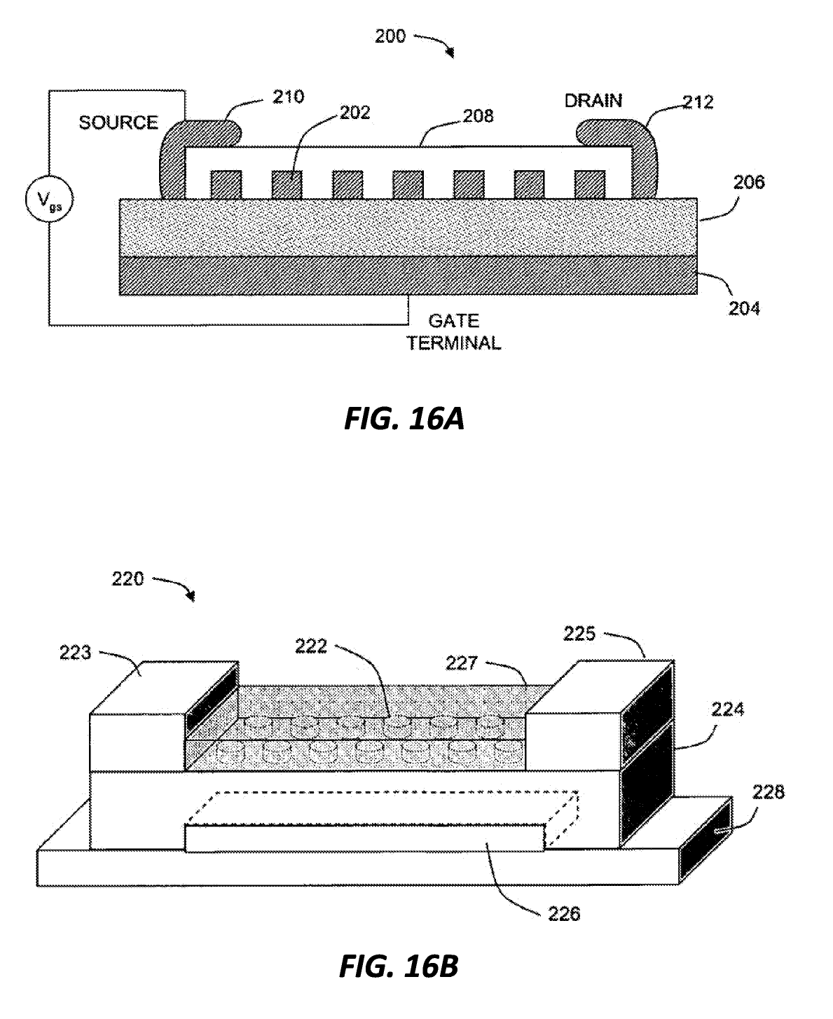

In some embodiments, at least one of the layers of a wavelength selective device provides a controllable electrical conductivity. Preferably, the conductivity of the associated layer can be controlled using an external control mechanism to alter the resonant performance of the wavelength selective device. Referring now to FIG. 16A, a wavelength selective device 200 includes a compound layer comprising an arrangement of compound surface elements 202 disposed above a ground layer 204. The compound surface elements 202 are isolated from each other and separated from the ground layer 204 by an intermediate isolating layer 206. The wavelength selective device 200 provides a resonant response to incident electromagnetic radiation that depends on one or more of the design features of the device 200 as described above. In the presence of electromagnetic radiation at wavelengths in and around the one or more resonant peaks, electromagnetic coupling fields are produced in and around the compound surface elements 202 and particularly within the insulating layer 206 between each of the elements 202 and a localized region of the ground layer 204.

In the exemplary embodiment, an over layer 208 of insulating material covers the surface elements 202. In particular, the over layer 208 is made from a material having an electrical conductivity value that can be altered by an external control mechanism. When controlled to have a first conductivity that is substantially insulating, the device 200 demonstrates a resonant response to one or more of reflectivity, absorption, and emissivity. The first conductivity can be said to provide a relatively high impedance value that sufficiently maintains electrical isolation of the conductive surface elements 202. Upon activation by the external control mechanism, the over layer 208 provides a second conductivity value that is non-insulating, or electrically conducting. Being electrically conductive, or having a relatively low impedance value, the over layer 208 changes the resonant response of the device 200.

In some embodiments, the over layer 208 includes a semiconductor, such as silicon. The semiconductor itself behaves as an insulator. When doped with an appropriate element, the semiconductor can become electrically conductive in the presence of an applied electric field. Such techniques are well known to those skilled in the art of semiconductor fabrication. In order to provide an electric field to the semiconductor material, at least two terminals are provided: a source terminal 210 and a drain terminal 212. The intermediate insulating layer 206 can include an oxide, and the electrically conducting metal ground plane 204 can be used as a gate terminal, such that the device represents a metal-oxide-semiconductor (MOS) field effect transistor (FET). In particular, the structure represents a form of transistor referred to as a thin-film transistor (TFT).

Upon application of a sufficient gate-to-source voltage (Vgs), the electrical conductivity of the semiconductor over layer 208 changes from insulating (off) to conducting (on). Having electrically conductive metal layers within them, the surface elements 202 are short circuited together. Such a substantial change to the structure quenches the electromagnetic fields previously established between the surface elements 202 and the ground layer 204, thereby change the resonant response. When the surface elements 202 are shorted together in this manner, the resonant response essentially disappears, such that the wavelength selective device 200 can be selectively turned on and off as desired by controlling voltage signal applied between the gate and source terminals. This can be used to modulate the resonant response, be it reflectivity, absorption, and emissivity, at speeds (e.g., kilohertz through megahertz, and higher) much faster than would otherwise be possible considering the thermal relaxation response of the device. Thus, the resonant response is no longer limited by a thermal relaxation between cycles.

In other embodiments, the device 200 includes a similar architecture with an over layer 208 formed from an optically responsive material, such as photovoltaic material. Without illumination, or with insufficient illumination below some threshold value, the photovoltaic material 208 is substantially insulating allowing the device 200 to exhibit a resonant response according to the design parameters of the device 200. When illuminated sufficiently, the conductivity of the over layer 208 changes, becoming non-insulating, or electrically conductive. Such an increase in electrical conductivity substantially changes the resonant behavior of the device 200 by altering, and in some instances, electrically short-circuiting the arrangement surface elements 202. Thus, resonant performance of the device at one or more wavelengths of interest can be substantially modified by application of light energy at the same or different wavelengths. In such an embodiment, there would be no need for either a source terminal 210 or a drain terminal 212.

The over layer 208 may be selected to respond to any suitable stimulus and/or analyte. In this way, the over layer may act as a switch such that the device 200 may be used to detect the presence or absence of said stimulus and/or analyte. For example, one or more properties of the over layer 208 may change in response to the presence of one or more chemical or biological material or the presence of light or current. In response to the presence of the stimulus and/or analyte, the over layer 208 may change from being a conductor to being an insulator or vice versa.

Referring to FIG. 16B, a top perspective view of one such device 220 is shown having an arrangement of surface elements 222 disposed on an insulating intermediate layer 224. A ground layer 226 is provided beneath the intermediate layer 224. An over layer 227 is applied over the arrangement of surface elements 222, having source terminal 223 and a drain terminal 225 disposed along opposite ends of the over layer 227. The entire device can be formed on a substrate 228. In some embodiments substrate 228 can be rigid, such as on a base Si wafer providing support to the transistor structure 220. In other embodiments, the substrate 228 can be flexible so that the device 220 can be contoured to the surface on which it is applied. At least one suitable flexible substrate includes polyimide films, commercially available from DuPont under the trade name KAPTON. Electrical contact can be made from an external source to one or more of the gate 226, source 223, and drain 225 terminals, such that application of an applied electrical signal can alter the conductivity of the over layer 227, thereby changing the resonant response of the wavelength selective device 220.

More generally, a similar approach can be used to controllably vary the conductivity of any one of the layers of a multi-layer wavelength selective device. In one embodiment, a ground plane layer can be included having a controllable conductivity. In some embodiments, the conductivity can be controlled by the application of an electrical signal. For example, the ground layer can include a suitably doped semiconductor material supporting an electrical current in the presence of an electric field above a threshold value. Thus, in the presence of a sufficient electric field, the ground layer becomes electrically conducting and the wavelength selective device operates according to the principals of the invention yielding a resonant response according to the chosen design parameters. However, upon variation of the electric field below the threshold, or its removal altogether, the ground layer becomes non-conducting, effectively removing the ground layer from the device. Such a substantial change in the configuration of the device quenches the standing wave electric fields in the dielectric and changes the overall reflection or absorption/emission resonance.

In another embodiment, the insulating layer includes a controllable conductivity. For example, the conductivity can be controlled by an electrical signal using a device such as a semiconductor for the insulating layer. Without application of a sufficient controlling electrical field, the insulating layer remains insulating allowing the wavelength selective device to operate according to the principals of the present invention yielding and providing a resonant response according to the chosen design parameters. However, upon the application of a sufficient electrical field, the insulating layer changes from insulating to non-insulating (or semi-insulating), thereby quenching the electromagnetic fields in the intermediate layer. Such a substantial change in the behavior of the ground layer alters the resonant performance, essentially turning the resonant performance off.

In addition to semiconductors, other materials can be used to provide an electrical conductivity controllable by an external control signal. Other examples include photovoltaic materials as described above and thermally responsive materials, such as pyroelectric materials that change conductivity in response to heat. Still other examples include chemically responsive materials, such as polymers that change conductivity in response to a local chemical environment. For example, the wavelength selective device includes an intermediate insulating layer formed from a photoconductor with a conductivity modified by incident light. Such a device would have an infrared reflection, and emission spectrum that could be modified by an external light source.

Alternatively or in addition, the intermediate layer includes a dielectric layer having an electrical conductivity that changes in response to its local chemical and/or physical environment. Such a device can serve as a remote sensor or tag for the relevant chemical or physical changes. Such a device can be remotely monitored through its infrared reflection/emission signature.

In yet other embodiments, the intermediate dielectric layer can have a conductivity or index of refraction that can be modified by a combination of the local environment and external illumination. One such example includes a fluorescent polymer. In yet other embodiments, any of the layers could be susceptible to mechanical deformation that could change the geometrical design of the engineered surface and tune the location, amplitude and bandwidth of at least one of the resonances. Such a change in design could impact the size or distance of the features, the thickness of the layers but not be limited to. In yet other embodiments, any of the layers including the over layer can consist of materials that can be tuned by or respond to external triggers that are not restricted to: temperature, chemical, bio, nuclear, mechanical, explosives analytes that in turn influence the location, amplitude and bandwidth of at least one of the resonances. This can result in tuning of the device response but can also alternative result in sensing of various parameters characteristic of the environment in which the device is, such as a gas, chemical, biological, explosives sensor.

Any of the above controllable devices can be used as an externally modulated, tuned electromagnetic emitter. This is particularly advantageous in the infrared band, wherein the device can be modulated rapidly, and faster than would otherwise be possible in view of thermal relaxation of the material.

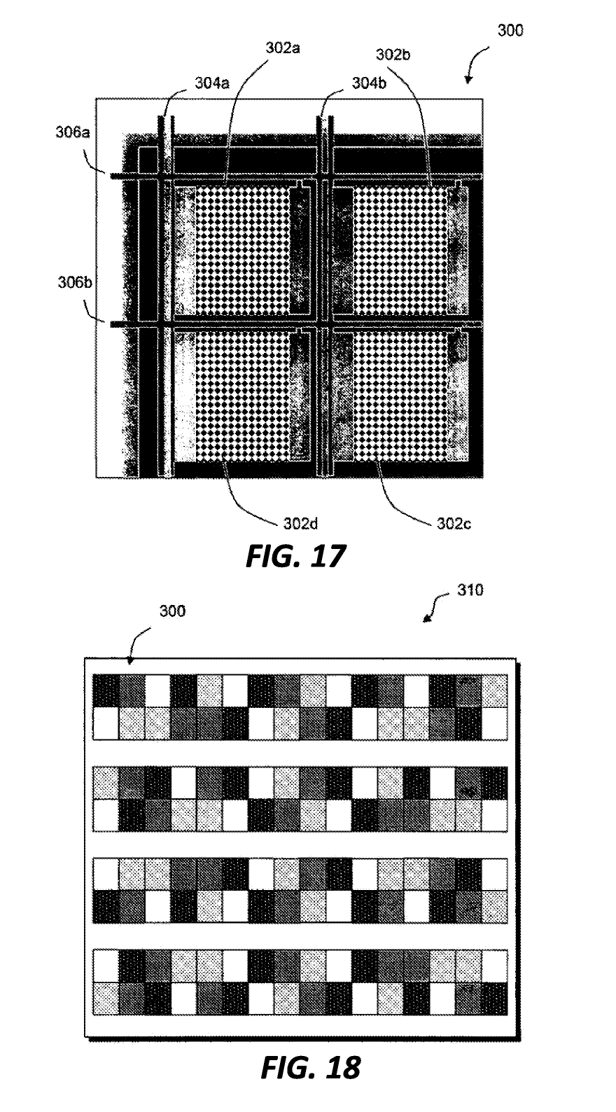

A wavelength selective device that selectively reflects, absorbs and/or emits electromagnetic radiation of a preferred wavelength can be used as a picture element, or pixel in a display device. Referring to FIG. 17, a pixel 300 is shown including a two-by-two rectangular matrix of sub-pixel elements 302a, 302b, 302c, 302d (generally 302). A pair of column electrodes 304a, 304b (generally 304) is aligned vertically, with each column electrode 304 connected to both sub-pixels 203 in its respective column. Likewise, a pair of row electrodes 306a, 306b (generally 306) is aligned horizontally, with each row electrode 306 connected to both sub-pixels 203 in its respective row. In particular, each of the sub-pixels can be individually addressed by applying a signal to the singular combination of column and row electrodes 304, 306 interconnected to the addressed sub-pixel 302. The pixel 300 can be formed on a substrate using techniques known to those skilled in the art of thin film displays, in which the film pixel elements include a resonant reflectivity and/or emissivity response as described herein.

A schematic representation of a matrix display is shown in FIG. 18, using an array of pixel 300 elements according to principles of the present invention. In some embodiments, each of the sub-pixels 302 provides a resonant response at a substantially equivalent wavelength, or at least within the same band (e.g., the same IR band). In some embodiments, the intensity of the reflective response can be varied according to an applied control signal of each sub pixel 302. Such variation can be used to vary the intensity of a reflectivity dip (absorption spike) without substantially changing its resonant wavelength. For emissivity applications, such variation of a control input can be used to vary the intensity of emission spike, without substantially changing its resonant wavelength. With variations in intensity, the display 310 can be compared to a black and white visual display, having an array of pixels each displaying a controllable shade of gray (i.e., intensity).

In other embodiments, the pixel 300 includes an array of sub-pixels 302 in which each sub-pixel is tuned to a different respective wavelength. Thus, alternatively or in addition to the ability to control intensity of each of the sub pixels 302 as described above, each of the sub-pixels 302 can be actuated to provide a variable intensity, variable wavelength response. With variations in intensity and wavelength, the display 310 can be compared to a color visual display, having an array of pixels each including an array of sub-pixels to display different colors and intensity.

Thus, a complex picture can be formed within a portion of the electromagnetic spectrum determined by the resonant wavelength (e.g., IR), using a matrix display formed from a matrix of wavelength selective device as described using the principles described herein. The matrix display 310 can operate in a reflection mode, in which the display 310 is illuminated by an external electromagnetic radiation (e.g., an external IR source). A detector receiving reflections from the matrix display 310 captures a two-dimensional image formed thereon by selective activation of the individual pixels 300 of the array 310.

Alternatively or in addition, the matrix display 310 can operate in an emission mode, in which the display 310 emits electromagnetic radiation (e.g., IR). A detector, without the need of an external IR source, receives emissions from the matrix display 310, capturing an image formed thereon through selective activation of the individual pixels 300 of the array 310. In emission mode, the device may be useful for, e.g., scene projection applications. In some embodiments, the device can be pulsed via an external signal at various frequencies. For example, the device may be pulsed at a frequency between 1Hz and 100MHz. However, embodiments are not limited to any particular frequency. In some embodiments, the device may be pulsed with an external signal that has a pattern. In some embodiments, the pattern may be a regular, periodic pattern. In other embodiments, the pattern may be an a periodic pattern. Each pulse of the pattern, whether it is periodic or a periodic, comprises a plurality of pulses, each pulse having a respective pulse width. After each pulse is a period of time when no pulse is present, each period of time having a corresponding time duration.

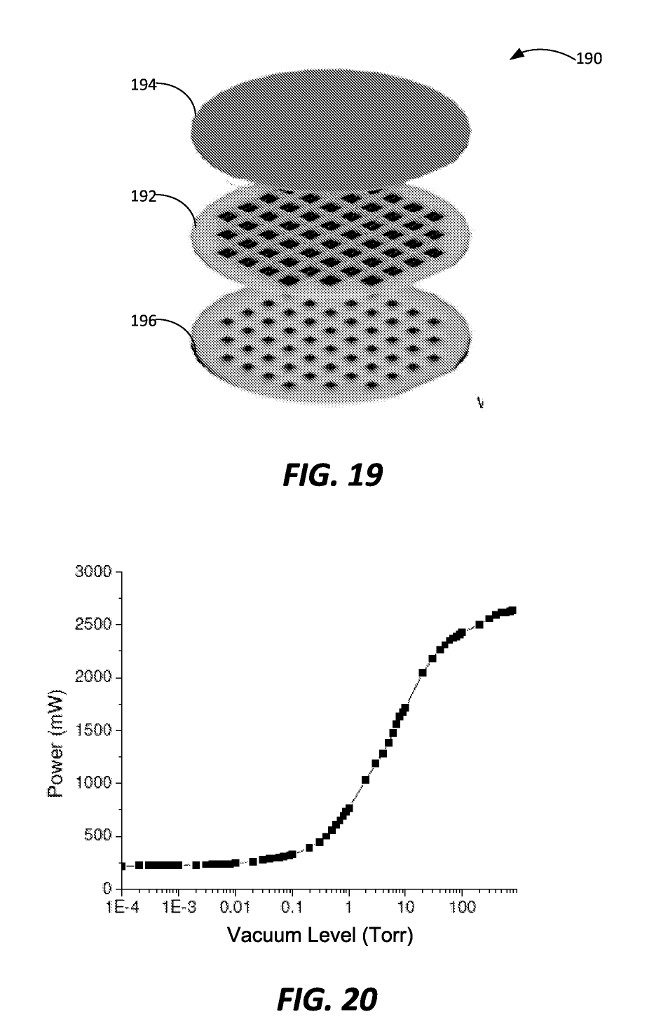

FIG. 19 illustrates wafer level vacuum packaging 190 of a wafer of multiple wavelength selective devices according to some embodiments. The wavelength selective device can be vacuum packaged individually or at wafer level. Any suitable wavelength selective device within wafer 192, as described above, may be place in a packaging that includes a window 194 that is substantially transparent in the portions of the electromagnetic spectrum where the devices of wafer 192 operate. The packaging 190 also includes a backing wafer 196, which may absorb gases present in the cavity of the devices or gases that may be emitted when the wafer 192 is heated within the packaging 190, in order to obtain and maintain a certain gas pressure within the device. The cavity of the device can also be back filled with a desired gas such as argon or nitrogen, or the atmosphere inside the cavity can be reduced to different levels of vacuum as desired.

In some embodiments, the window 194 may include an anti-reflection coating which may be formed from one layer or multiple layers of dissimilar materials or can be formed out of photonic crystal anti-reflection coating. A photonic crystal anti-reflection (AR) coating may include an array of holes or patches in a host material, such as silicon. For example, the photonic crystal anti-reflection coating may include silicon with holes of a particular depth and a diameter. For example, in some embodiments, the depth of the holes may be between 1 and 2 micrometers and the diameter of the holes may be between 1 and 6 micrometers. Using an AR coating may increase the coupling of light into and out from the device 192. Forming a photonic crystal anti-reflection coating out of the window host material could render the device more robust for further on processing. Ordinary AR coatings might not survive or could be degraded by subsequent vacuum packaging steps with raised temperature, while a photonic crystal AR would be more robust to such processing steps and maintain its performance.

The packaging 190 may be formed in any suitable way. For example, the three components 192, 194 and 196 may be placed together in a vacuum chamber and then hermitically sealed to keep the vacuum in the packaging 190 even when removed from the vacuum chamber. The vacuum level within the packaging may be determined by a number of parameters of this process, including a size of a getter within the chamber, a bake out time of the chamber, and the vacuum level at the time of bonding.

The vacuum level within the packaging 190 may have important effects on the operation of the device 192. In some embodiments, the speed at which the device 192 may be pulsed may be determined, at least in part, on the vacuum level with the packaging 190. For example, a higher vacuum level may reduce the switching speed of the device. Also, as illustrated in FIG. 20, the operating power of the device 192 may be decreased by maintaining a high vacuum level. Reducing the input power requirements of the device 192 has the advantage of prolonging the batter life of a portable product using the device 192 and, optionally, reducing the size of the battery used to power the device 192 relative to the size that would be needed absent the presence of a vacuum. Accordingly, there is a trade-off between speed of switching and power consumption. In some embodiments, the device 192 may be operating at higher switching speeds, but with increased power consumption. In other embodiments, the device 192 may be operated at lower switching speeds, but with higher power efficiency.

FIG. 20 illustrates that there are also diminishing returns with respect to power efficiency when the vacuum level is increased beyond a certain point. Accordingly, in some embodiments, the vacuum level of the packaging 190 is maintained in the 0.001-1 Ton range. In other embodiments, the vacuum level may be maintained in the 0.002-0.2 Torr range. In this way, the power efficiency may be increased without requiring exceptionally high vacuum levels.

This invention is not limited in its application to the details of construction and the arrangement of components set forth in the foregoing description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Various aspects of the present invention may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the invention may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

While this invention has been particularly shown and described with references to preferred embodiments thereof, it will be understood by those skilled in the art that various changes in form and details may be made therein without departing from the scope of the invention encompassed by the appended claims.

What is claimed is:

1. A tunable electromagnetic radiation device comprising:
a wavelength selective structure comprising a plurality of layers, the plurality of layers comprising:
a compound layer comprising a plurality of surface elements, wherein the compound layer comprises:
at least one metallic layer or metallic-like layer; and
at least one dielectric layer;
an electrically isolating intermediate layer, wherein the compound layer is in contact with a first surface of the electrically isolating intermediate layer; and
a continuous electrically conductive layer in contact with a second surface of the electrically isolating intermediate layer,
wherein the wavelength selective structure has at least one reflective or absorptive resonance band; and
an electrode in electrical contact with at least one of the compound layer, the electrically isolating intermediate layer, and the continuous electrically conductive layer,
wherein the wavelength selective structure comprises a material having a material property that is variable in response to an external signal applied to the tunable electromagnetic radiation device, and wherein variation in the material property tunes the at least one reflective, absorptive, or emissive resonance band.

2. The tunable electromagnetic radiation device of claim 1, wherein the electrically isolating intermediate layer comprises a dielectric and/or semiconductor layer.

3. The tunable electromagnetic radiation device of claim 1, wherein the material property is at least one property selected from the group consisting of a conductivity, an index of refraction, an index of absorption, and physical dimensions of one or more of the plurality of layers.

4. The tunable electromagnetic radiation device of claim 1, wherein the material property is varied by changing the temperature of one or more of the plurality of layers and/or changing a current or voltage provided to one or more of the plurality of layers.

5. The tunable electromagnetic radiation device of claim 1, wherein tuning the reflective or absorptive resonance band comprises moving the at least one resonance band from the mid-wavelength infrared (MWIR) portion of the electromagnetic spectrum to the long wavelength infrared (LWIR) portion of the electromagnetic spectrum.

6. The tunable electromagnetic radiation device of claim 1, wherein the at least one metallic or metallic-like layer comprises a plurality of metallic or metallic-like layers.

7. The tunable electromagnetic radiation device of claim 1, wherein the at least one dielectric layer comprises a plurality of dielectric layers.

8. The tunable electromagnetic radiation device of claim 1, wherein the at least one reflective, absorptive or emissive resonance band comprises a plurality of resonance bands.

9. The tunable electromagnetic radiation device of claim 8, wherein a first resonance band of the plurality of resonance bands is in the mid-wavelength infrared (MWIR) portion of the electromagnetic spectrum and a second resonance band of the plurality of resonance bands is in the long wavelength infrared (LWIR) portion of the electromagnetic spectrum.

10. The tunable electromagnetic radiation device of claim 9, wherein a third resonance band of the plurality of resonance bands is in the short wavelength infrared (SWIR) portion of the electromagnetic spectrum.

11. The tunable electromagnetic radiation device of claim 8, wherein the plurality of resonance bands have substantially equal efficiencies.

12. The tunable electromagnetic radiation device of claim 8, wherein the plurality of resonance bands have substantially unequal efficiencies.

13. The tunable electromagnetic radiation device of claim 1, wherein a location, a bandwidth and/or an amplitude of the at least one reflective, absorptive or emissive resonance band is based, at least in part, on at least one property selected from the group consisting of a periodicity of the plurality of surface elements, a defect in an array of the plurality of surface elements, a size of the plurality of surface elements, a thickness of the at least one metallic or metallic-like layer and/or the at least one dielectric layer, and the properties of the materials used in the at least one metallic or metallic-like layer and/or the at least one dielectric layer.

14. The tunable electromagnetic radiation device of claim 1, wherein a first subset of the plurality of surface elements have a first size and/or a first shape and a second subset of the plurality of surface elements have a second size and/or a second shape.

15. The tunable electromagnetic radiation device of claim 1, wherein the plurality of surface elements are arranged in in an arrangement selected from one of a group consisting of an a periodic array, a periodic array and a random array.

16. The tunable electromagnetic radiation device of claim 15, wherein the arrangement is a periodic array selected from the group consisting of: a rectangular grid; a square grid; a triangular grid; an Archimedean grid; an oblique grid; a centered rectangular grid; and a hexagonal grid.

17. The tunable electromagnetic radiation device of claim 1, wherein each surface element of the plurality of surface elements has a shape selected from the group consisting of:
a circle; an ellipse; an annular ring; a rectangle; a square; a square ring; a triangle; a polygon;
a hexagon; a parallelogram; a cross; a Jerusalem cross; a double circle; an open annular ring;
and an open square ring.

18. The tunable electromagnetic radiation device of claim 1, wherein the plurality of surface elements do not contact one another.

19. The tunable electromagnetic radiation device of claim 1, wherein the plurality of surface elements are connected via a connecting surface feature.

20. The tunable electromagnetic radiation device of claim 1, wherein the surface elements have a size of less than about 50 micrometers.

21. The tunable electromagnetic radiation device of claim 20, wherein the surface elements have a size of less than about 0.5 micrometers.

22. The wavelength selective structure of claim 1, wherein the surface elements are raised patches.

23. The wavelength selective structure of claim 1, wherein the surface elements are holes.

24. The tunable electromagnetic radiation device of claim 1, further comprising a vacuum-sealed package comprising a transparent window, wherein the wavelength selective element is within the vacuum-sealed package.

25. The tunable electromagnetic radiation device of claim 1, wherein the tunable electromagnetic radiation device is pulsed.

26. The tunable electromagnetic radiation device of claim 25, wherein a speed at which the tunable electromagnetic radiation device is pulsed is based, at least in part, on a vacuum level within the vacuum-sealed package.

27. The tunable electromagnetic radiation device of claim 24, wherein a vacuum level within the vacuum-sealed package is determined by a getter size, a bake out time or a vacuum level at a time of bonding.

28. The tunable electromagnetic radiation device of claim 24, wherein the transparent window comprises a photonic crystal antireflection coating.

29. The tunable electromagnetic radiation device of claim 1, wherein the continuous electrically conductive layer comprises an electrically activated thermal source in communication with the electrode, wherein the external signal activates the thermal source.

30. The tunable electromagnetic radiation device of claim 1, further comprising:
an infrared radiation source in thermal communication with at least one of the plurality of layers, the device selectively emitting infrared radiation in the at least one reflective or absorptive resonance band.

31. The tunable electromagnetic radiation device of claim 32, wherein the infrared radiation source comprises a filament.

32. The tunable electromagnetic radiation device of claim 33, wherein the electrical filament includes the continuous electrically conductive layer.

33. The tunable electromagnetic radiation device of claim 1, wherein the external signal comprises at least one signal selected from the group consisting of an electrical signal, a chemical signal, a biological signal, a mechanical signal, an optical signal, and a thermal signal.

34. The tunable electromagnetic radiation device of claim 1, wherein two or more of the compound layer, the electrically isolating intermediate layer and the continuous electrically conductive layer are configured to provide a controllable switch, the electrode configured to receive an electrical input for controlling the switch.

35. The tunable electromagnetic radiation device of claim 1, wherein the electrically isolating intermediate layer comprises a semiconductor material having a controllable electrical conductivity responsive to an electrical input.

36. The tunable electromagnetic radiation device of claim 1, wherein the electrically isolating intermediate layer comprises a pyroelectric material having a controllable electrical conductivity responsive to a thermal input.

37. The tunable electromagnetic radiation device of claim 1, wherein the electrically isolating intermediate layer comprises a optically responsive material having a controllable electrical conductivity responsive to an optical input.

38. The tunable electromagnetic radiation device of claim 1, wherein the electrically isolating intermediate layer comprises a chemically responsive material having a controllable electrical conductivity responsive to a chemical input.

39. An electromagnetic radiation detector comprising:
a wavelength selective structure comprising a plurality of layers, the plurality of layers comprising:
a compound layer comprising a plurality of surface elements, wherein the compound layer comprises:
at least one metallic layer; and
at least one dielectric layer;
an electrically isolating intermediate layer, wherein the compound layer is in contact with a first surface of the electrically isolating intermediate layer; and
a continuous electrically conductive layer in contact with a second surface of the electrically isolating intermediate layer,
wherein the wavelength selective structure has at least one reflective or absorptive resonance band; and
an electrode in electrical contact with at least one of the compound layer, the electrically isolating intermediate layer, and the continuous electrically conductive layer,
wherein the wavelength selective structure comprises a material having a material property that is variable in response to an external signal applied to the detector via the electrode, and wherein variation in the material property tunes the at least one absorptive resonance band, and
wherein the detector is configured to detect electromagnetic radiation in the at least one absorptive resonance band.

40. A method of selectively reflecting incident electromagnetic radiation, the method comprising:
providing a wavelength selective structure comprising a plurality of layers, the plurality of layers comprising:
a compound layer comprising a plurality of surface elements, wherein the compound layer comprises:
at least one metallic layer; and
at least one dielectric layer;
an electrically isolating intermediate layer, wherein the compound layer is in contact with a first surface of the electrically isolating intermediate layer; and
a continuous electrically conductive layer in contact with a second surface of the electrically isolating intermediate layer,
wherein the wavelength selective structure has at least one resonance band for selectively reflecting or absorbing incident visible or infrared radiation;
receiving the incident electromagnetic radiation at the wavelength selective structure;
absorbing a first portion of the incident electromagnetic radiation in the at least one resonant absorption band; and
reflecting a second portion of the incident electromagnetic radiation outside of the at least one resonant absorption band.

41. A method of emitting electromagnetic radiation, the method comprising:
providing a wavelength selective device comprising a plurality of layers, the plurality of layers comprising:
a compound layer comprising a plurality of surface elements, wherein the compound layer comprises:
at least one metallic layer; and
at least one dielectric layer;
an electrically isolating intermediate layer, wherein the compound layer is in contact with a first surface of the electrically isolating intermediate layer; and
a continuous electrically conductive layer in contact with a second surface of the electrically isolating intermediate layer,
wherein the wavelength selective device has at least one resonance emission band; and
an electrode in electrical contact with at least one of the compound layer, the electrically isolating intermediate layer, and the continuous electrically conductive layer,
wherein the wavelength selective device comprises a material having a material property that is variable in response to an external signal applied to the tunable electromagnetic radiation device via the electrode, and wherein variation in the material property tunes the at least one resonance emission band; and
heating the wavelength selective device such that the wavelength selective device emits radiation in the at least one resonance emission band.

42. The method of claim 41, further comprising using the wavelength selective device as a detector.
